(19) United States
(12) Patent Application Publication
(10) Pub. No.: US 2024/0320294 A1
(43) Pub. Date: Sep. 26, 2024

(54) INFORMATION PROCESSING METHOD, INFORMATION PROCESSING APPARATUS, AND COMPUTER PROGRAM PRODUCT

(71) Applicant: KABUSHIKI KAISHA TOSHIBA, Tokyo (JP)

(72) Inventor: Yoshikazu HANATANI, Komae Tokyo (JP)

(73) Assignee: KABUSHIKI KAISHA TOSHIBA, Tokyo (JP)

(21) Appl. No.: 18/521,531

(22) Filed: Nov. 28, 2023

(30) Foreign Application Priority Data
Mar. 22, 2023 (JP) 2023-045482

(51) Int. Cl. G06F 17/16

(52) U.S. Cl. CPC G06F 17/16

(57) ABSTRACT

According to an embodiment, an information processing method is executed by a computer. The method includes generating processed data obtained by performing, on original data including a group of a plurality of data values arranged respectively at position coordinates along a predetermined direction on a map, at least one of an addition process of adding a predetermined data value representing an analysis target at position coordinates in a non-analysis target region in the original data and a deletion process of deleting data values of at least part of the position coordinates in the original data, where data values at the at least part match between a plurality of pieces of the original data.

### CROSS-REFERENCE TO RELATED APPLICATIONS

This application is based upon and claims the benefit of priority from Japanese Patent Application No. 2023-045482, filed on Mar. 22, 2023; the entire contents of which are incorporated herein by reference.

### FIELD

Embodiments described herein relate generally to an information processing method, an information processing apparatus, and a computer program product.

### BACKGROUND

Analysis of original data is requested to an analysis institution. Furthermore, in order to suppress confidential leakage of original data, the original data is processed and then requested to an analysis institution. For example, the original data is divided into a plurality of pieces of data, and only a part of the data is disclosed to each of a plurality of the analysis institutions to request analysis. Furthermore, a chip range which is an analysis target region arranged on a wafer is detected by edge detection, processing of deleting a predetermined portion such as an outer periphery of the detected chip range or a data string at predetermined intervals is performed, and then analysis is requested.

However, conventionally, a deletion portion in the processed data from the original data can be accurately specified, and the original data may be easily estimated by interpolating the deleted data to the processed data. That is, in the prior art, there is a case where it is not possible to suppress leakage of confidential information.

### BRIEF DESCRIPTION OF THE DRAWINGS

FIG. 1 is a schematic diagram of an information processing system;

FIG. 2 is a block diagram of a functional configuration of an information processing apparatus;

FIG. 3A is an explanatory diagram of original data;

FIG. 3B is an explanatory diagram of original data;

FIG. 4A is an explanatory diagram of processing pattern information;

FIG. 4B is an explanatory diagram of processing pattern information;

FIG. 5A is an explanatory diagram of a replacement function;

FIG. 5B is an explanatory diagram of position coordinates before and after replacement;

FIG. 6A is an explanatory diagram of processing of original data;

FIG. 6B is an explanatory diagram of processing of original data;

FIG. 6C is an explanatory diagram of processing of original data;

FIG. 6D is an explanatory diagram of processing of original data;

FIG. 7 is a flowchart illustrating a flow of information processing;

FIG. 8 is a flowchart illustrating a flow of processing;

FIG. 9 is a flowchart illustrating a flow of an addition process;

FIG. 10 is a flowchart illustrating a flow of a coordinate replacement process;

FIG. 11 is a flowchart illustrating a flow of a two-dimensional data conversion process;

FIG. 12 is a block diagram of a functional configuration of an information processing apparatus;

FIG. 13 is an explanatory diagram of a deletion process;

FIG. 14 is a flowchart illustrating a flow of information processing;

FIG. 15 is a flowchart illustrating a flow of processing;

FIG. 16 is a flowchart illustrating a flow of a deletion process;

FIG. 17 is a flowchart illustrating a flow of a coordinate replacement process; and

FIG. 18 is a hardware configuration diagram.

### DETAILED DESCRIPTION

According to an embodiment, an information processing method is executed by a computer. The method includes generating processed data obtained by performing, on original data including a group of a plurality of data values arranged respectively at position coordinates along a predetermined direction on a map, at least one of an addition process of adding a predetermined data value representing an analysis target at position coordinates in a non-analysis target region in the original data and a deletion process of deleting data values of at least part of the position coordinates in the original data, where data values at the at least part match between a plurality of pieces of the original data.

Hereinafter, an information processing apparatus, an information processing method, and an information processing program will be described in detail with reference to the accompanying drawings.

### First Embodiment

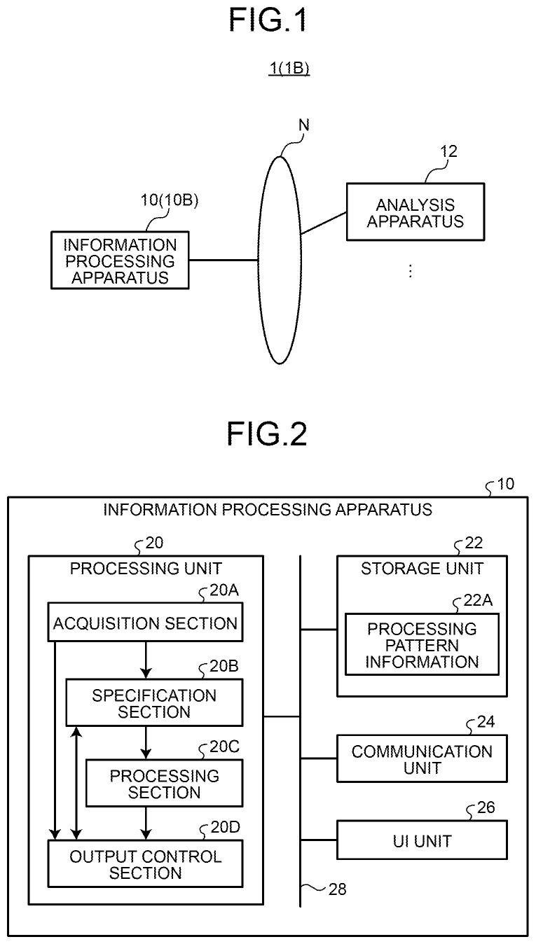

FIG. 1 is a schematic diagram illustrating an example of an information processing system 1 according to the present embodiment.

The information processing system 1 includes an information processing apparatus 10 and an analysis apparatus 12. The information processing apparatus 10 and the analysis apparatus 12 are communicably connected via a wireless or wired communication network such as a network N.

The information processing apparatus 10 is a dedicated or general-purpose computer. The information processing apparatus 10 is an apparatus that requests the analysis apparatus 12 to analyze original data. Details of the original data will be described later.

The analysis apparatus 12 is a dedicated or general-purpose computer. The analysis apparatus 12 is an analysis apparatus that analyzes data received from the information processing apparatus 10. The information processing system 1 may include a plurality of analysis apparatuses 12. The plurality of analysis apparatuses 12 are managed by different companies, individuals, or groups, for example.

FIG. 2 is a block diagram illustrating an example of a functional configuration of the information processing apparatus 10.

The information processing apparatus 10 includes a processing unit 20, a storage unit 22, a communication unit 24, and a user interface (UI) unit 26. The processing unit 20, the storage unit 22, the communication unit 24, and the UI unit 26 are connected via a bus 28 so as to be able to exchange data or signals.

Note that at least one of the storage unit 22, the communication unit 24, and the UI unit 26 may be connected to the processing unit 20 via the network N. That is, at least one of the storage unit 22, the communication unit 24, and the UI unit 26 may be provided in an external device connected to the information processing apparatus 10 via the network N. Furthermore, at least one of functional units described later included in the processing unit 20 may be provided in the external device. The external device is, for example, an external server.

The storage unit 22 stores various data. In the present embodiment, the storage unit 22 stores processing pattern information 22A. Details of the processing pattern information 22A will be described later. Furthermore, the storage unit 22 may store processed data, various parameters, and the like that are processing results by the processing unit 20 described later. Details of the processed data will be described later.

The storage unit 22 is, for example, a random access memory (PAU), a semiconductor memory element such as a flash memory, a hard disk, an optical disk, or the like. Note that the storage unit 22 may be a storage device provided outside the information processing apparatus 10. Furthermore, the storage unit 22 may be a storage medium. Specifically, the storage medium may store or temporarily store a program or various types of information downloaded via a local area network (LAN), the Internet, or the like. Furthermore, the storage unit 22 may include a plurality of storage media.

The communication unit 24 communicates with each of the plurality of analysis apparatuses 12 and the external device via the network N. For example, the communication unit 24 transmits various types of information to the analysis apparatuses 12 or receives various types of information from the analysis apparatuses 12.

The UI unit 26 has a function of receiving an operation input by a user and a function of outputting various types of information.

For example, the UI unit 26 includes a display and an input unit. The display displays various types of information. The display is, for example, a known organic electro-luminescence (EL) display, a liquid crystal display (LCD), a projection device, or the like. The input unit receives various instructions from the user. An input unit 10E is, for example, a keyboard, a mouse, a touch panel, a microphone, or the like. Note that the UI unit 26 may be configured by a touch panel including an input mechanism and an output mechanism. Furthermore, the UI unit 26 may further include a speaker that outputs sound.

The processing unit 20 includes an acquisition section 20A, a specification section 20B, a processing section 20C, and an output control section 20D. At least one of the acquisition section 20A, the specification section 20B, the processing section 20C, and the output control section 20D is realized by, for example, one or a plurality of processors. For example, each of the above units may be realized by causing a processor such as a central processing unit (CPU) to execute a program, that is, by software. Each of the above units may be realized by a processor such as a dedicated integrated circuit (IC), that is, hardware. Each of the above units may be realized by using software and hardware in combination. In the case of using a plurality of processors, each processor may implement one of the respective units, or may implement two or more of the respective units.

The acquisition section 20A acquires a plurality of pieces of original data.

The original data is data to be analyzed. In other words, the original data is data that is a source of a request for analysis to the analysis apparatus 12.

The analysis target is, for example, an article to be analyzed. The article is, for example, an electrical appliance, a vehicle, an electrical appliance, a component mounted on a vehicle, or the like, but is not limited thereto. The component is, for example, but not limited to, an electronic circuit, a silicon wafer, or the like. Note that the analysis target is not limited to the article, and may be a group of data classified according to a predetermined classification rule. In the present embodiment, it is assumed that the analysis target is a silicon wafer on which a plurality of chips is mounted.

The original data includes a group of a plurality of data values arranged respectively at position coordinates along a predetermined direction on the map. The map is a unit of data to be analyzed of the original data, and means a state in which a data value included in the original data is arranged in a one-dimensional space or a K-dimensional space. K is an integer of 1 or more. The data value is a state value representing a state of each position coordinate.

In the present embodiment, a form in which the map is a two-dimensional map arranged in a two-dimensional space will be described as an example. Therefore, in the present embodiment, a mode in which the predetermined direction that is the arrangement direction of the data values on the map is a K-dimensional direction (K=2 in the present embodiment) including a first direction on the map and a second direction intersecting the first direction will be described as an example. The description will be given assuming that the first direction is an x-axis direction and the second direction is a y-axis direction orthogonal to the x-axis direction. That is, in the present embodiment, a mode in which the data values included in the original data are arranged respectively at position coordinates represented by the x coordinates and the y coordinates orthogonal to each other of the map represented by the two-dimensional space will be described as an example. Furthermore, in the present embodiment, a mode in which the map is a two-dimensional map along the plate surface of the silicon wafer to be analyzed will be described as an example. Furthermore, in the present embodiment, a mode in which the map has a square shape along a two-dimensional plane will be described as an example. Note that the shape of the map is not limited to a square shape.

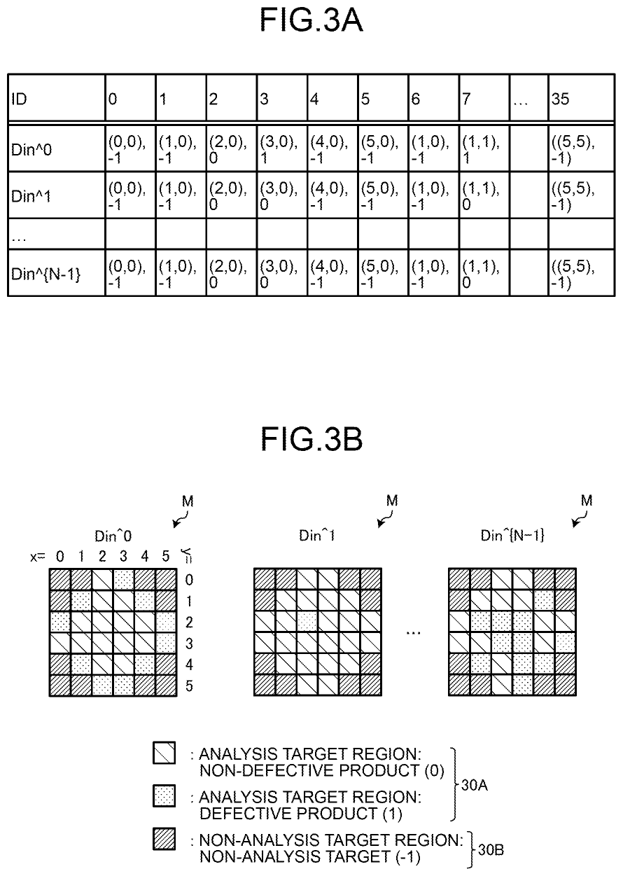

FIGS. 3A and 3B are explanatory diagrams of an example of the original data Din. FIG. 3A is a schematic diagram illustrating an example of a data format of each of a plurality of pieces of the original data Din acquired by the acquisition section 20A. FIG. 3B is an image diagram illustrating the original data Din arranged on the map M.

FIGS. 3A and 3B illustrate, as an example, the original data Din including N pieces of partial data from partial data Din\hat{ }0 to partial data Din\hat{ }{N−1}. N is an integer of 1 or more, and corresponds to the number of partial data of the original data Din acquired by the acquisition section 20A as a unit to be processed. That is, the acquisition section 20A acquires original data Din={Din\hat{ }0, . . . , Din\hat{ }{N−1}} including N pieces of partial data as a processing target. Furthermore, in the present embodiment, a mode in which the acquisition section 20A acquires the original data Din including data values arranged at each of two-dimensional position coordinates, that is, the original data Din of two-dimensional data will be described as an example.

FIG. 3A illustrates, as an example, a data configuration in which an ID that is identification information of partial data of the original data Din is associated with a plurality of pieces of data constituting the partial data Din\hat{ }i identified by the ID. However, i is an integer from 0 to N−1, and the partial data Din\hat{ }i is i-th data of the original data Din. Furthermore, the ID of Din\hat{ }i may be an order i in the original data Din. Furthermore, matters common to any partial data of the original data Din will be described using the partial data Din\hat{ }i as an example. In FIG. 3A, the numbers 0, 1, 2, 3, 4, 5, 6, 7, . . . , and Num−1 given along the horizontal axis are numbers given to the data values included in the partial data Din\hat{ }i, and correspond to identification numbers of the data values of the position coordinates. Num is the number of pieces of data of the data value included in the partial data Din\hat{ }i. The number of pieces of data of the data values constituting the partial data Din\hat{ }i may be described as a data size. For example, in a case where the partial data Din\hat{ }i has a square shape with x coordinates of 0, 1, . . . , n−1 and y coordinates of 0, 1, . . . , n−1, Num=n*n−1.

For example, each of the plurality of pieces of data constituting the partial data Din\hat{ }i is represented by ((x, y), v_i_j). x represents an x coordinate value, and y represents a y coordinate value. v_i_j represents a data value defined in the position coordinates (x, y). Furthermore, in a case where the shape has a square shape in which the x coordinate is 0, 1, . . . , n−1 and the y coordinate is 0, 1, . . . , n−1, it can be expressed as ((x, y), v_i_{x+ny}).

In the present embodiment, a case where the data value included in the original data Din is a data value representing either an analysis target region 30A or a non-analysis target region 30B will be described as an example.

The analysis target region 30A is a region in which data values to be analyzed are arranged on the map M. In the present embodiment, a case where the analysis target region 30A represents a region where chips are arranged in the map M representing a silicon wafer will be described as an example.

Furthermore, in the present embodiment, a case where values representing the states of chips arranged at position coordinates in the analysis target region 30A are defined as data values of position coordinates in the analysis target region 30A in the map M in each partial data Din\hat{ }i of the original data Din will be described. Examples of the value representing the state of the chip include a data value representing an inspection result of the chip. In the present embodiment, it is assumed that a data value representing an inspection result is defined as a data value representing a state of a chip at each position coordinate in the analysis target region 30A of the partial data Din\hat{ }i. The data value indicating the inspection result of the chip is, for example, “0” indicating that the chip is a non-defective product or “1” indicating that the chip is a defective product.

Note that the data value representing the inspection result of the chip is not limited to “0” and “1”. Furthermore, the data value of each of the position coordinates in the analysis target region 30A is not limited to the data value representing the inspection result of the chip.

The non-analysis target region 30B is a region in which data values not to be analyzed are arranged on the map M. In the present embodiment, a case where the non-analysis target region 30B represents a region where no chip is arranged in the map M representing the silicon wafer will be described as an example. Specifically, a description will be given on the assumption that a data value “−1” representing non-analysis target is defined for each position coordinate in the non-analysis target region 30B on the map M. Note that the data value indicating non-analysis target is not limited to “−1”.

Therefore, the present embodiment will be described assuming a case where any one of “0” representing a non-defective product, “1” representing a defective product, and “−1” representing non-analysis target is defined as the data value v_i_j, which is a state value representing a state defined in each of the position coordinates (x, y) of each partial data Din\hat{ }i of the original data Din.

That is, in the present embodiment, the data value of the position coordinates (x, y) represented by the data ((x, y), v_i_j=0) included in the partial data Din the chip state “non-defective product”. Furthermore, the data value of the position coordinates (x, y) represented by the data ((x, y), v_i_j=1) included in the original data Din represents the chip state “defective product”. Furthermore, the data value of the position coordinates (x, y) represented by ((x, y), v_i_j=−1) represents the state “not to be analyzed” of the chip. Note that these data formats are examples, and may be other data formats.

The acquisition section 20A acquires a group of a plurality of pieces of original data Din to be processed from another external information processing apparatus or the like via the network N. Furthermore, the acquisition section 20A may acquire a plurality of pieces of original data Din by reading a group of a plurality of pieces of original data Din to be processed stored in the storage unit 22. The output control section 20D outputs the plurality of pieces of original data Din acquired by the acquisition section 20A to the specification section 20B as a processing target unit. Note that it is assumed that the partial data Din\hat{ }i included in the group of the plurality of pieces of original data Din to be processed acquired by the acquisition section 20A have the same data size and the same number of pieces of data in the analysis target region 30A.

In the present embodiment, a description will be given assuming that the acquisition section 20A acquires a group of partial data Din\hat{ }0 to partial data Din\hat{ }{N−1} including all the partial data Din\hat{ }i of a group of a plurality of pieces of original data Din illustrated in FIGS. 3A and 3B as a processing unit.

Returning to FIG. 2, the description will be continued.

The specification section 20B specifies the processing pattern Pd used for processing the plurality of pieces of partial data Din\hat{ }i acquired by the acquisition section 20A. The specification section 20B specifies one processing pattern Pd for a group of partial data Din\hat{ }i of a plurality of pieces of original data Din to be processed acquired by the acquisition section 20A.

The processing pattern Pd is a pattern in which a processing rules of the partial data Din\hat{ }i are defined respectively for position coordinates on the map M. The processing unit 20 generates the processed data Dout by processing each data value of the position coordinates included in the partial data Din\hat{ }i according to the processing rule indicated by the processing pattern Pd. The processing pattern Pd is a pattern in which this processing rule is defined in advance.

Specifically, the processing pattern Pd is a pattern that defines, for each position coordinate of the map M, as a state value, a non-setting target code “−1” representing that a data value in the partial data Din\hat{ }i is not to be set or a setting target code “2” representing that a data value of the original data Din is to be set.

The setting target code is a code indicating that the data value of the partial data Din\hat{ }i is to be set. The non-setting target code is a code indicating that the data value of the partial data Din\hat{ }i is not a target to be set. Note that the setting target code and the non-setting target code are not limited to “2” and “−1” as long as each code is a value to be identified.

The specification section 20B specifies the processing pattern Pd from the processing pattern information 22A stored in the storage unit 22.

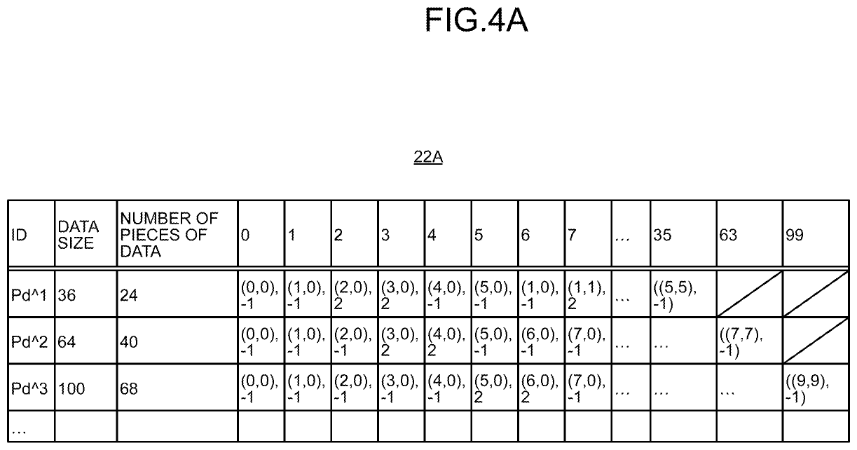

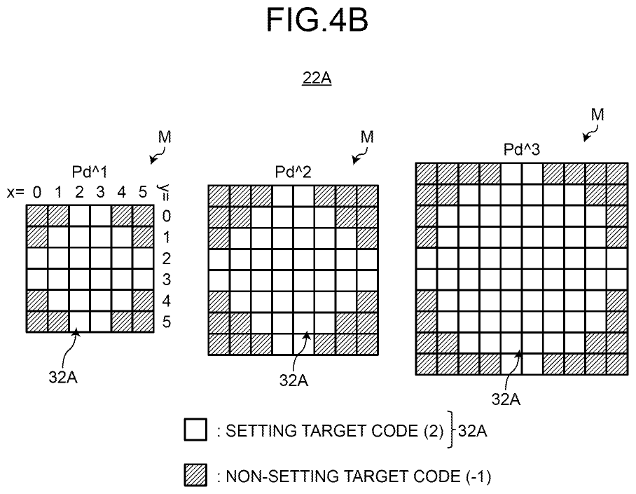

FIGS. 4A and 4B are explanatory diagrams of an example of the processing pattern information 22A. FIG. 4A is a schematic diagram illustrating an example of a data format of each of a plurality of processing patterns Pd. FIG. 4B is an image diagram illustrating each of the processing patterns Pd arranged on the map M.

The processing pattern information 22A is information in which a plurality of different processing patterns Pd of at least a part of the processing rule is registered.

As illustrated in FIG. 4A, the ID of the processing pattern Pd and the data size, the number of pieces of data, and the number of pieces of data of the data size of the processing pattern Pd identified by the corresponding ID are registered in the processing pattern information 22A in association with each other. A plurality of different processing patterns Pd of at least one of the data size and the number of pieces of data are registered in the processing pattern information 22A.

In FIG. 4A, ID represents identification information of the processing pattern Pd. FIGS. 4A and 4B illustrate Pd1 to Pd3 as an example of the ID of the processing pattern Pd. Note that tn the processing pattern information 22A, four or more processing patterns Pd may be registered.

The data size indicated in the processing pattern information 22A is the data size of the processing pattern Pd. FIGS. 4A and 4B illustrate, as an example, a processing pattern Pd1 having 6 stages in each of the x-axis direction and the y-axis direction and a data size of 6×6=36, a processing pattern Pd2 having a data size of 8×8=64, and a processing pattern Pd3 having a data size of 10×10=100.

The number of pieces of data registered in the processing pattern information 22A is the number of position coordinates included in a region 32A where the setting target code is defined in the processing pattern Pd. In other words, the number of pieces of data registered in the processing pattern information 22A is the number of setting target codes included in the region 32A in which the setting target code is defined in the processing pattern Pd.

In FIG. 4A, the numbers 0, 1, 2, 3, 4, 5, 6, 7, . . . , and Num−1 given along the horizontal axis are numbers given to the respective values included in the processing pattern Pd, and correspond to identification numbers of the values of the respective position coordinates.

For example, each of the plurality of values constituting the processing pattern Pd\hat{ }i is represented by ((x_i_j, y_i_j), v_i_j). (x_i_j, y_i_j) is a position coordinate in the processing pattern Pd\hat{ }i, and represents an x coordinate and a y coordinate. v_i_j represents a state value of the position coordinates of the processing pattern Pd\hat{ }i. As described above, the state value of each position coordinate of the processing pattern Pd\hat{ }i is, for example, the non-setting target code “−1” or the setting target code “2”.

Therefore, ((x_i_j, y_i_j), v_i_j=−1) means that “−1” not to be analyzed is set to the position coordinates (x_i_j, y_i_j) in the processing result. Furthermore, ((x_i_j, y_i_j), v_i_j=2) means that a data value determined from the processing result is set to position coordinates (x_i_j, y_i_j) in the processing result. Note that this data format of the processing pattern Pd is merely an example, and another data format may be used.

As illustrated in FIG. 4B, in the present embodiment, in the processing pattern Pd, the setting target code “2” is defined at position coordinates in a region having a shape similar to the shape of the analysis target region 30A in the original data Din. Specifically, the region 32A in which the setting target code is defined in the processing pattern Pd has a shape similar to the shape of the analysis target region 30A (see FIG. 3B) in the original data Din.

Furthermore, in the present embodiment, in the processing pattern Pd, a non-setting target code “−1” or a deletion code “−1” is defined on the outer periphery of the region 32A where the setting target code “2” is defined.

Therefore, in the present embodiment, a mode in which the processing pattern Pd has a code representing a processing rule determined in advance so as to maintain the shape of the analysis target region 30A included in the original data Din to be processed will be described as an example. Note that the shape of the region 32A in which the setting target code is defined in the processing pattern Pd and the shape of the analysis target region 30A of the original data Din are not limited to similar shapes.

Returning to FIG. 2, the description will be continued.

The specification section 20B specifies one processing pattern Pd corresponding to the group of the partial data Din\hat{ }i of the plurality of original data Din acquired by the acquisition section 20A from the processing pattern information 22A.

Specifically, the specification section 20B specifies the processing pattern Pd having a data size larger than the data size of the partial data Din\hat{ }i of the plurality of pieces of original data Din acquired by the acquisition section 20A, and having the region 32A in which the setting target code is defined, and the number of pieces of data in which is larger than the number of pieces of data of the analysis target region 30A included in the partial data Din\hat{ }i.

As described above, the acquisition section 20A acquires, as the plurality of pieces of original data Din to be processed, the plurality of pieces of original data Din including partial data Din\hat{ }i having the same data size and the same number of pieces of data in the analysis target region 30A. Therefore, the specification section 20B may measure the data size (the number of pieces of data) of one partial data Din\hat{ }i among the plurality of pieces of original data Din acquired by the acquisition section 20A and the number of pieces of data in the analysis target region 30A. Then, the specification section 20B specifies one or a predetermined number of a plurality of processing patterns Pd having a data size larger than the measured data size, and having the number of pieces of data larger than the number of pieces of data of the analysis target region 30A included in the partial data Din\hat{ }i from the processing pattern information 22A. The specification section 20B specifies arbitrary one piece of processing pattern information 22A as a processing pattern Pd used for processing the original data Din from the acquired one or more processing patterns Pd.

Furthermore, the specification section 20B acquires, from the processing pattern information 22A, one or a predetermined number of the plurality of processing patterns Pd having a data size larger than the data size of the partial data Din\hat{ }i of the group of the plurality of original data Din acquired by the acquisition section 20A and the number of pieces of data larger than the number of pieces of data of the analysis target region 30A included in the partial data Din\hat{ }i. Then, the output control section 20D outputs a list of one or a plurality of processing patterns Pd acquired by the specification section 20B to the UI unit 26. For example, a display screen representing the plurality of processing patterns Pd illustrated in FIG. 4B is displayed on the UI unit 26. The user selects one desired processing pattern Pd by operating the UI unit 26 while visually recognizing the UI unit 26.

The specification section 20B specifies one processing pattern Pd selected by an operation instruction of the UI unit 26 by the user among one or a plurality of processing patterns Pd output to the UI unit 26 as the processing pattern Pd used for processing the plurality of pieces of original data Din.

Furthermore, the specification section 20B acquires information indicating a processing parameter from the UI unit 26. For example, the output control section 20D displays a screen prompting the input of the processing parameter on the UI unit 26. The user inputs a desired processing parameter by operating the UI unit 26. The specification section 20B acquires information indicating the processing parameter from the UI unit 26. Then, the specification section 20B selects, from the processing pattern information 22A, the processing pattern Pd having a data size larger than the data size of the partial data Din\hat{ }i of the group of the plurality of pieces of original data Din acquired by the acquisition section 20A, the number of pieces of data larger than the number of pieces of data of the analysis target region 30A included in the partial data Din\hat{ }i, and corresponding to the processing parameter for which the input has been received. The specification section 20B specifies the selected processing pattern Pd as the processing pattern Pd used for processing the original data Din.

Furthermore, the specification section 20B acquires, from the processing pattern information 22A, the processing pattern Pd having a data size larger than the data size of the partial data Din\hat{ }i of the group of the plurality of pieces of original data Din acquired by the acquisition section 20A and the number of pieces of data larger than the number of pieces of data of the analysis target region 30A included in the partial data Din\hat{ }i. Then, the specification section 20B outputs a list of the acquired processing patterns Pd to the UI unit 26. Then, the specification section 20B may specify one Pd selected by an operation instruction of the UI unit 26 by the user as the processing pattern Pd used for processing the original data Din including the plurality of pieces of partial data Din\hat{ }i.

Note that the output control section 20D may further output the one processing pattern Pd specified by the specification section 20B to the UI unit 26 as the processing pattern Pd used for processing the group of the partial data Din\hat{ }i of the plurality of pieces of original data Din acquired by the acquisition section 20A. Furthermore, when the acquisition section 20A acquires a group of the partial data Din\hat{ }i of the plurality of original data Din, the output control section 20D may display the plurality of acquired partial data Din\hat{ }i on the UI unit 26.

Next, the processing section 20C will be described.

The processing section 20C executes an addition process of adding a predetermined data value representing the analysis target to the position coordinates of the non-analysis target region 30B in the original data Din acquired by the acquisition section 20A.

Specifically, the processing section 20C executes the addition process on each of the partial data Din\hat{ }i of the plurality of original data Din using one processing pattern Pd specified by the specification section 20B.

The processing section 20C calculates the number obtained by subtracting the number of pieces of data in the analysis target region 30A included in the partial data Din\hat{ }i from the number of pieces of data in the region 32A that is included in the processing pattern Pd specified by the specification section 20B, and in which the setting target code is defined. Then, the processing section 20C performs processing of adding the subtracted number of predetermined data values representing the analysis target to the position coordinates of the non-analysis target region 30B of the partial data Din\hat{ }i.

As described above, in the present embodiment, the specification section 20B specifies the processing pattern Pd having a data size larger than the data size of the partial data Din\hat{ }i included in the original data Din and the number of pieces of data larger than the number of pieces of data of the analysis target region 30A included in the partial data Din\hat{ }i.

For example, it is assumed that the acquisition section 20A acquires the original data Din including the partial data Din\hat{ }i having the data size “36” illustrated in FIGS. 3A and 3B and the number of pieces of data “24” in the analysis target region 30A. In this case, the specification section 20B specifies the processing pattern Pd2 or the processing pattern Pd3 which is the processing pattern Pd having the data size, the data size larger than the number of pieces of data, and the number of pieces of data (See FIGS. 4A and 4B). The description will be continued assuming that the specification section 20B specifies the processing pattern Pd2. In this case, the processing section 20C calculates the number “16” obtained by subtracting the number of pieces of data “24” of the original data Din from the number of pieces of data “40” of the region 32A that is included in the processing pattern Pd2, and in which the setting target code is defined. Then, the processing section 20C adds a predetermined data value representing the number “16” of analysis targets to the position coordinates of the non-analysis target region 30B for each piece of partial data Din\hat{ }i of the original data Din.

Specifically, the processing section 20C converts the partial data Din\hat{ }i of the original data Din\hat{ }into one-dimensional partial data Din_1\hat{ }i, sequentially reads each partial data Din_1\hat{ }i of the one-dimensional original data Din_1, adds a predetermined data value representing an analysis target, and sequentially sets the data value to each position coordinate of the post-addition original data that is the data after the addition process along the processing pattern Pd, thereby executing the addition process. In other words, the processing section 20C sequentially sets the additional data in which the predetermined data value is added to the data value in the analysis target region 30A of the partial data Din\hat{ }i of the original data Din to each of the plurality of position coordinates included in the region 32A in which the setting target code is defined in the processing pattern Pd specified by the specification section 20B, thereby generating the post-addition original data which is the data after the addition process.

The processing section 20C uses, as the added predetermined data value, a data value representing the largest number of states in the analysis target region 30A among a plurality of types of states represented by the data value illustrated in the analysis target region 30A of the partial data Din of the original data Din\hat{ }i. For example, it is assumed that a total value is calculated by adding the numbers of non-defective products “0” and defective products “1” of all the partial data Din\hat{ }i among the non-defective products “0” and the defective products “1”, which are examples of the data values representing the states represented by the data values shown in the analysis target region 30A of the partial data Din of the original data Din, and the total value of the data values representing the non-defective products “0” is the largest. In this case, the processing section 20C may use “0” representing a non-defective product as the predetermined data value to be added.

The processing section 20C may use the post-addition original data generated by the process of adding a data value to the original data Din as the processed data Dout.

In the present embodiment, the processing section 20C further performs a coordinate replacement process of replacing position coordinates of at least some data values of the plurality of data values in the analysis target region 30A with other position coordinates in the analysis target region 30A. In the present embodiment, a mode in which the processing section 20C performs the addition process and the coordinate replacement process on the original data Din to generate processed data Dout will be described as an example.

The processing section 20C may perform the coordinate replacement process at any one timing before or after the addition process is performed on each partial data Din\hat{ }i of the original data Din. For example, the processing section 20C may add the data value by the addition process after performing the coordinate replacement process on the partial data Din\hat{ }i. Furthermore, the processing section 20C may perform the coordinate replacement process at both timings before and after performing the addition process on the partial data Din\hat{ }i.

In the present embodiment, a mode in which the processing section 20C performs the coordinate replacement process after adding the data value by the addition process for each partial data Din\hat{ }i of the original data Din will be described as an example.

The coordinate replacement process is a process of replacing position coordinates of at least some data values of a plurality of data values in the analysis target region 30A with other position coordinates in the analysis target region 30A. In other words, the coordinate replacement process is a process of replacing at least some position coordinates with other position coordinates by shuffling the data of the analysis target region 30A in the post-addition original data Din_1 in the analysis target region 30A with respect to each partial data Din\hat{ }i of the original data Din or each partial data Din_1 of the post-addition original data Din_1 obtained by adding a data value to the original data Din by the addition process. The analysis target region 30A in the original data Din or the post-addition original data Din_1 in which the data value is added to the addition process is a region of the specified position coordinates of “0” representing the non-defective product or “1” representing the defective product as the data value v_i_j that is the state value.

The processing section 20C performs the coordinate replacement process using a replacement function Rp.

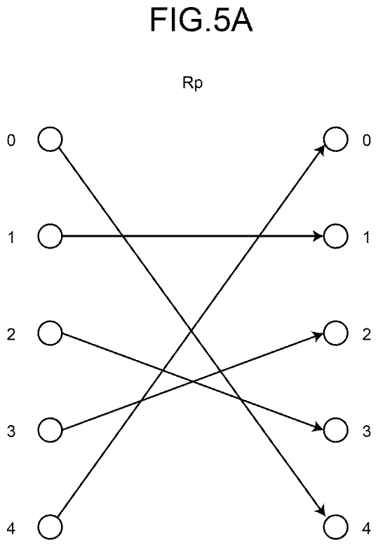

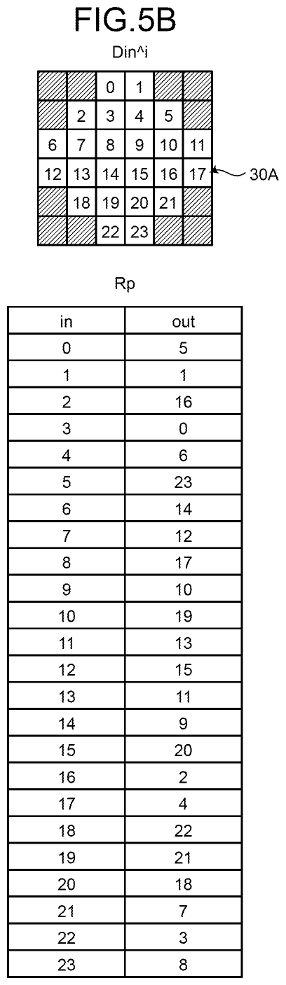

FIG. 5A is an explanatory diagram of an example of the replacement function Rp.

The replacement function Rp is, for example, a function representing a surjective and injective mapping. For example, the replacement function Rp is represented by {0, . . . , nv−1}→{0, . . . , nv−1}. In this formula, nv is the number of pieces of data in the analysis target region 30A in the original data Din.

As illustrated in FIG. 5A, for example, the replacement function Rp is a function for replacing each position coordinate of, for example, 0 to 4 in which the data value is defined with another position coordinate. Note that the replacement function Rp may be a function representing pseudo-random replacement. In the present embodiment, a form in which the replacement function Rp is a function representing a surjective and injective mapping will be described as an example.

FIG. 5B is an explanatory diagram of an example of position coordinates before and after replacement by the partial data Din\hat{ }i and the replacement function Rp. For example, it is assumed that a number of 0 to 23 is assigned to each position coordinate in the analysis target region 30A included in the partial data Din\hat{ }i. Then, as illustrated in FIG. 5B, it is assumed that the replacement function Rp is a function for replacing the number of position coordinates represented in the field of “in” in the replacement function Rp with the number of position coordinates represented in the field of “out” in the replacement function Rp. In this case, the processing section 20C performs the coordinate replacement process on the partial data Din\hat{ }i using the replacement function Rp, so that the data value defined in the position coordinates of the number represented in the field of “in” in the analysis target region 30A of the partial data Din\hat{ }i is shuffled to become the data value of the position coordinates of the number represented in the corresponding field of “out”. In the present embodiment, the processing section 20C performs the coordinate replacement process on the post-addition partial data generated by performing the addition process on the partial data Din\hat{ }i instead of the partial data Din\hat{ }i.

The processing section 20C specifies the replacement function Rp using the number of pieces of data nv in the analysis target region 30A in the post-addition original data.

First, the processing section 20C calculates the number of pieces of data nv in the analysis target region 30A in the post-addition original data.

Note that it is assumed that the data size of the partial data Din\hat{ }i of the plurality of original data Din acquired by the acquisition section 20A and the number of pieces of data constituting the analysis target region 30A are the same. Furthermore, the processing section 20C generates the post-addition original data using one processing pattern Pd with respect to the partial data Din\hat{ }i of the plurality of pieces of original data Din to be processed acquired by the acquisition section 20A. Therefore, the number of pieces of data values added to the partial data Din\hat{ }i of the corresponding original data Din of the plurality of post-addition original data generated for each of the partial data Din\hat{ }i of the plurality of original data Din is the same.

Therefore, the processing section 20C may calculate the number of pieces of data nv constituting the analysis target region 30A for one post-addition original data among the plurality of generated post-addition original data.

Next, the processing section 20C selects one replacement function Rp to be used for a plurality of pieces of post-addition original data. For example, the processing section 20C randomly selects the replacement function Rp from a set of replacement functions represented by {0, . . . , nv−1}→{0, . . . , nv−1} using the number of pieces of data nv constituting the analysis target region 30A.

Then, the processing section 20C executes the coordinate replacement process for each post-addition original data with respect to the plurality of post-addition original data.

Specifically, the processing section 20C selects one position coordinate having not been subjected to coordinate replacement in the analysis target region 30A in the post-addition original data. Then, the processing section 20C sets the data value of the selected position coordinate in the post-addition original data to the position coordinate after the replacement in which the position coordinate is replaced by the replacement function Rp. The processing section 20C performs these processes on all position coordinates in the analysis target region 30A in the post-addition original data, thereby generating the processed data Dout subjected to the addition process and the coordinate replacement process.

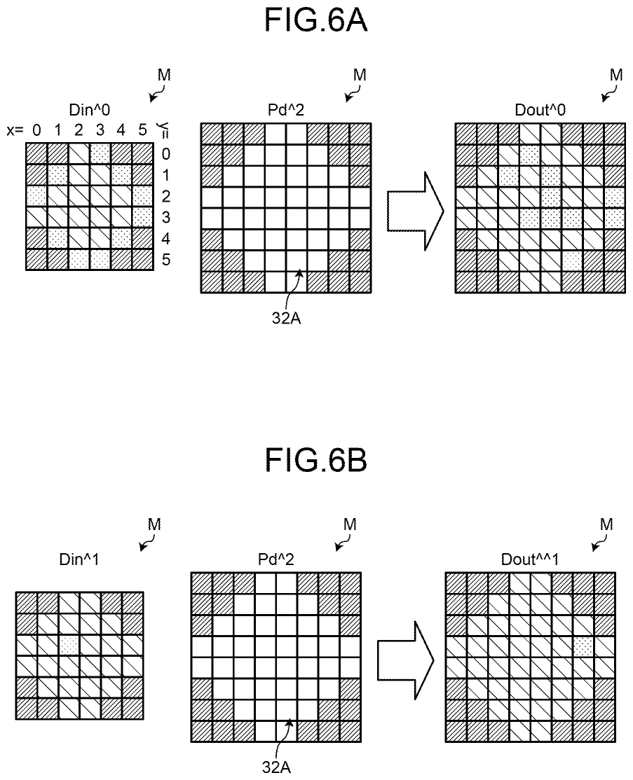

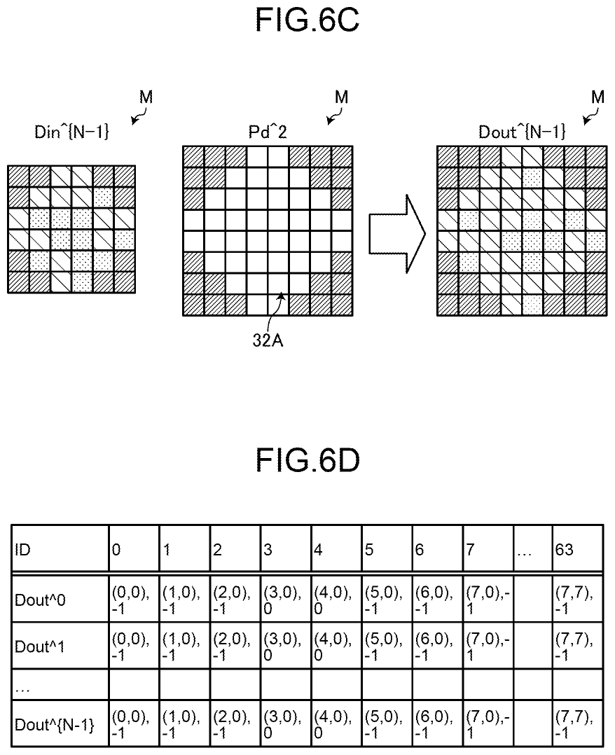

FIGS. 6A to 6D are explanatory diagrams of an example of processing of the original data Din by the processing section 20C.

FIG. 6A is an explanatory diagram of an example of the processing of generating the processed data Dout by performing the addition process on the partial data Din\hat{ }0 of the original data Din illustrated in FIGS. 3A and 3B using the processing pattern Pd\hat{ }2 illustrated in FIGS. 4A and 4B and further performing the coordinate replacement process.

FIG. 6B is an explanatory view of an example of the processing of generating the processed data Dout\hat{ }1 by performing the addition process on the partial data Din\hat{ }1 illustrated in FIGS. 3A and 3B using the processing pattern Pd\hat{ }2 illustrated in FIGS. 4A and 4B and further performing the coordinate replacement process.

FIG. 6C is an explanatory view of an example of the processing of generating the processed data Dout\hat{ }{N−1} by performing the addition process on the partial data Din\hat{ }{N−1} illustrated in FIGS. 3A and 3B using the processing pattern Pd2 illustrated in FIGS. 4A and 4B and further performing the coordinate replacement process.

FIG. 6D is a schematic diagram of an example of a data configuration of each of the processed partial data Dout\hat{ }0 to the processed partial data Dout\hat{ }{N−1} of the processed data Dout generated by performing the addition process on the partial data Din\hat{ }0 to the partial data Din\hat{ }{N−1} of the original data Din using the processing pattern Pd\hat{ }2 and further performing the coordinate replacement process.

As illustrated in FIG. 6D, the processing section 20C performs the addition process and the coordinate replacement process on the partial data Din\hat{ }0 to the partial data Din\hat{ }{N−1} of the N pieces of original data Din using the processing pattern Pd, thereby generating the processed partial data Dout\hat{ }0 to the processed partial data Dout\hat{ }{N−1} of the N pieces of processed data Dout. Each processed partial data Dout\hat{ }i includes m pieces of data corresponding to the identifier ID. Each of the plurality of pieces of data constituting the processed data Dout is represented by ((x, y), v_i_j) similarly to the original data Din. x represents an x coordinate value, and y represents a y coordinate value. v_i_j represents a data value defined in the position coordinates (x, y).

Since the processing section 20C performs the addition process of adding the predetermined data value representing the analysis target to the position coordinates of the non-analysis target region 30B in each partial data Din\hat{ }i of the original data Din, the processed data Dout generated by the addition process is difficult to estimate the original data Din from the processed data Dout. Therefore, the processing section 20C can generate the processed data Dout capable of suppressing leakage of confidential information.

Returning to FIG. 2, the description will be continued.

The output control section 20D outputs various types of information.

For example, as described above, the output control section 20D displays each partial data Din\hat{ }i of the plurality of pieces of original data Din acquired by the acquisition section 20A on the UI unit 26. Furthermore, the output control section 20D displays a list of one or a plurality of processing patterns Pd acquired by the specification section 20B on the UI unit 26. Furthermore, the output control section 20D may display one processing pattern Pd specified by the specification section 20B on the UI unit 26 as the processing pattern Pd used for processing the plurality of pieces of original data Din acquired by the acquisition section 20A. Furthermore, when the acquisition section 20A acquires a plurality of pieces of original data Din, the output control section 20D may display each partial data Din\hat{ }i of the acquired plurality of pieces of original data Din on the UI unit 26. Then, the output control section 20D may display a list of the plurality of processing patterns Pd registered in the processing pattern information 22A on the UI unit 26.

Furthermore, the output control section 20D may store the processed data Dout processed by the processing section 20C in the storage unit 22. At this time, the output control section 20D may store the information regarding the processing pattern Pd used for processing the processed data Dout and the original data Din of the processing source of the processed data Dout in the storage unit 22 in association with each other. The information regarding the processing pattern Pd is, for example, information such as the processing pattern Pd used for processing the processed data Dout, the data size used for specifying the processing pattern Pd, and the replacement function Rp.

Furthermore, the output control section 20D may transmit the processed data Dout processed by the processing section 20C to the analysis apparatus 12 identified by a predetermined destination via the communication unit 24. The predetermined destination may be input by, for example, an operation of the UI unit 26 by the user. Furthermore, the predetermined destination may be stored in the storage unit 22 in advance.

Furthermore, the output control section 20D may transmit the processed data Dout stored in the storage unit 22 to the analysis apparatus 12 of a predetermined destination when an instruction to transmit the processed data Dout to the analysis apparatus 12 is input according to an operation instruction of the UI unit 26 by the user.

Next, an example of a flow of information processing executed by the information processing apparatus 10 according to the present embodiment will be described.

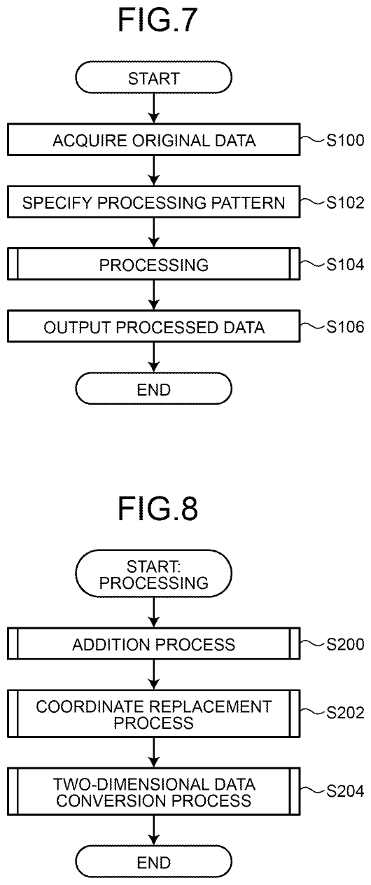

FIG. 7 is a flowchart illustrating an example of a flow of information processing executed by the information processing apparatus 10 according to the present embodiment.

The acquisition section 20A acquires a plurality of pieces of original data Din to be processed (step S100).

The specification section 20B specifies one processing pattern Pd corresponding to the original data Din acquired in step S100 from the processing pattern information 22A stored in the storage unit 22 (step S102). The specification section 20B specifies the processing pattern Pd having a data size larger than the data size of each partial data Din\hat{ }i of the plurality of pieces of original data Din acquired in step S100, and having the region 32A in which the setting target code is defined, and the number of pieces of data in which is larger than the number of pieces of data of the analysis target region 30A included in each partial data Din\hat{ }i.

Then, the processing section 20C performs processing including the addition process and the coordinate replacement process on each partial data Din the plurality of original data Din acquired in step S100, thereby generating processed data Dout including the plurality of processed partial data Dout\hat{ }i (step S104). A detailed flow of the processing in step S104 will be described later.

The output control section 20D outputs a plurality of pieces of the processed data Dout generated by the processing in step S104 (step S106). For example, the output control section 20D outputs the plurality of processed data Dout to at least one of the storage unit 22, the UI unit 26, and the analysis apparatus 12. Then, this routine is ended.

Next, a detailed flow of the processing (step S104 in FIG. 7) executed by the processing section 20C will be described.

FIG. 8 is a flowchart illustrating an example of a flow of processing executed by the processing section 20C. The flowchart of FIG. 8 is a flowchart illustrating a detailed flow of the processing in step S104 of FIG. 7.

The processing section 20C performs an addition process on the plurality of pieces of original data Din acquired in step S100 (see FIG. 7) using the processing pattern Pd specified in step S102 (see FIG. 7) (step S200). Details of the flow of the addition process in step S200 will be described later.

Then, the processing section 20C performs a coordinate replacement process on one-dimensional post-addition original data generated by the addition process in step S200 (step S202). Details of the flow of the coordinate replacement process in step S202 will be described later.

The processing section 20C converts the one-dimensional processed data Dout generated by the coordinate replacement process in step S202 into two-dimensional data (step S204), and ends this routine. Details of the flow of the two-dimensional data conversion process in step S204 will be described later.

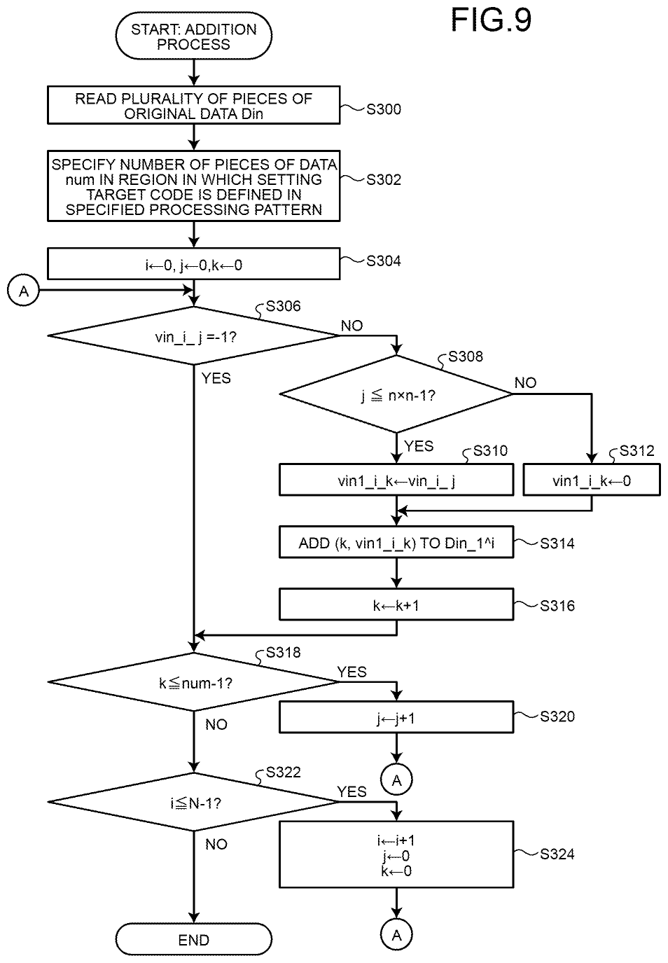

FIG. 9 is a flowchart illustrating an example of a flow of the addition process. The flowchart of FIG. 9 is a flowchart illustrating a detailed flow of the addition process of step S200 of FIG. 8.

In the addition process illustrated in FIG. 9, the processing section 20C converts each of the plurality of pieces of original data Din acquired by the acquisition section 20A into the one-dimensional original data Din_1, sequentially reads each piece of the one-dimensional original data Din_1, adds a predetermined data value representing the analysis target, and sequentially sets the data value to each position coordinate of the post-addition original data that is the data after the addition process along the processing pattern Pd, thereby generating the one-dimensional post-addition original data Din_1. In FIG. 9, a mode in which the predetermined data value to be added is “0” representing a non-defective product will be described as an example.

First, the processing section 20C reads original data Din, which is a plurality of pieces of two-dimensional data acquired by the acquisition section 20A (step S300). Then, the processing section 20C specifies the number of pieces of data num of the region 32A in which the setting target code “2” is defined in the processing pattern Pd specified by the specification section 20B (step S302).

Then, the processing section 20C performs a process of setting the partial data Din\hat{ }i as the one-dimensional original data Din_1\hat{ }i for each partial data Din\hat{ }i of the original data Din which is the two-dimensional data, sequentially reading the data value for each position coordinate, and adding the non-defective product “0” which is the predetermined data value to be added until the number of pieces of data num specified in step S302 is reached.

Specifically, the processing section 20C sets “0” as an initial value for each of i, j, and k (step S304).

i is a count value for counting the partial data Din\hat{ }i subjected to the addition process, and can take a value in a range of 0 to N−1. j is a count value for counting the data value vin_i_j of the processed position coordinates in the partial data Din\hat{ }i to be processed, and may be a value in a range of 0 or more and n×n−1 or less. k is a count value for counting a data value representing the non-defective product “0” or the defective product “1” included in the one-dimensional post-addition original data Din_1\hat{ }i after the data value is added, the data value being generated from the partial data Din\hat{ }i by the addition process by the processing section 20C. k may have a value in a range of 0 or more and num−1 or less.

Then, the processing section 20C determines whether or not the data value v_i_j of the position coordinates of an unprocessed head processing target in the partial data Din\hat{ }i to be processed is “−1” representing non-analysis target (step S306). When a negative determination is made in step S306 (step S306: No), the process proceeds to step S308.

In step S308, the processing section 20C determines whether or not j is n×n−1 or less (step S308). The processing section 20C determines whether or not the count value j of the processed position coordinates is less than or equal to n×n−1. When an affirmative determination is made in step S308 (step S308: Yes), the process proceeds to step S310.

In step S310, the processing section 20C sets the data value v_i_j of the position coordinates of the processing target used for the determination in step S306 as the data value vin1_i_k which is a state value of the head position for which the data value is not set in the i-th one-dimensional post-addition original data Din_1\hat{ }i being generated (step S310). Then, the process proceeds to step S314.

On the other hand, when a negative determination is made in step S308 (step S308: No), the process proceeds to step S312. In step S312, the processing section 20C sets the data value representing the non-defective product “0” as the data value vin1_i_k which is the state value of the head position for which the data value is not set in the i-th one-dimensional post-addition original data Din_1\hat{ }i in processing (step S312). Then, the process proceeds to step S314.

In step S314, the processing section 20C adds data (k, vin1_i_k) to the i-th one-dimensional post-addition partial data Din_1\hat{ }i being generated (step S314). That is, the processing section 20C sets the data value set in step S310 or step S312 to k, which is the head position for which the data value is not set, in the i-th one-dimensional post-addition original data Din_1\hat{ }i being generated.

Next, the processing section 20C counts up k by 1 (step S316), and proceeds to step S318.

In step S318, the processing section 20C determines whether or not k is less than or equal to the number of pieces of data num−1 specified in step S302 (step S318). When an affirmative determination is made in step S308 (step S318: Yes), the processing section 20C counts up j by 1 (step S320), and the process returns to step S306 described above.

When a negative determination is made in step S318 (step S318: No), the process proceeds to step S322. In step S322, the processing section 20C determines whether or not i is less than or equal to N−1 (step S322). N is the number of pieces of original data Din acquired by the acquisition section 20A. That is, the processing section 20C determines whether or not there is original data Din for which the processing of steps S306 to S318 has not been completed among the plurality of pieces of original data Din acquired by the acquisition section 20A. When an affirmative determination is made in step S322 (step S322: Yes), the process proceeds to step S324. In step S324, the processing section 20C counts up i by 1, sets j and k to “0”, and then returns to step S306 described above. On the other hand, when a negative determination is made in step S322 (step S322: No), this routine is ended.

By executing the addition process illustrated in FIG. 9, the processing section 20C generates, from the plurality of original data Din, data Din_1 including one-dimensional post-addition partial data Din_1\hat{ }i in which a data value representing the non-defective product “0” is added to the one-dimensional data of each partial data Din\hat{ }i.

Next, a detailed flow of the coordinate replacement process (step S202 in FIG. 8) executed by the processing section 20C will be described.

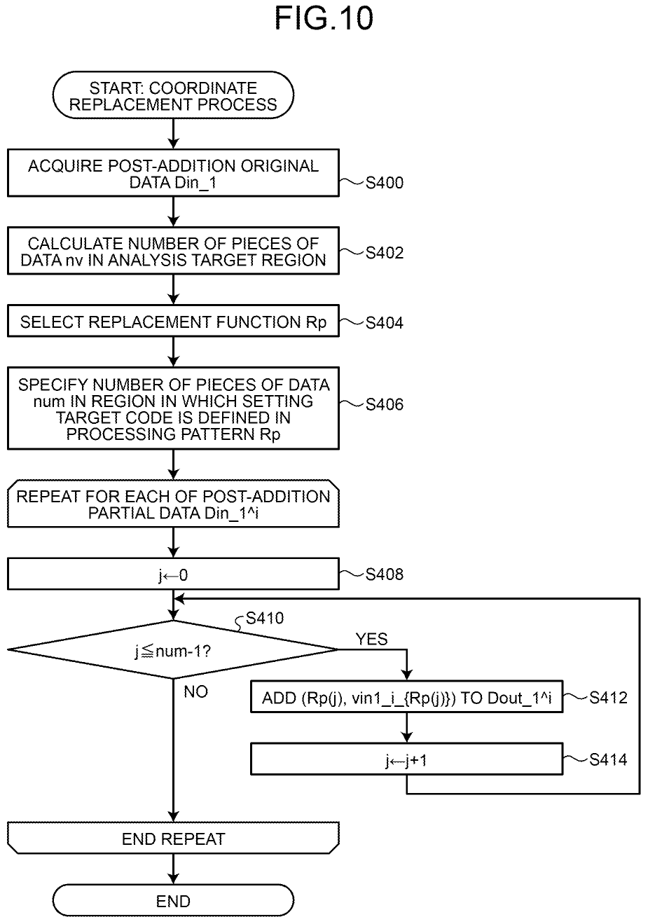

FIG. 10 is a flowchart illustrating an example of a flow of the coordinate replacement process executed by the processing section 20C. The flowchart of FIG. 10 is a flowchart illustrating a detailed flow of the processing in step S202 of FIG. 8.

The processing section 20C acquires one-dimensional post-addition original data Din_1 including a plurality of one-dimensional post-addition partial data Din_1\hat{ }i generated by the addition process (step S400).

Then, the processing section 20C calculates the number of pieces of data nv in the analysis target region 30A in the one-dimensional post-addition original data Din_1 acquired in step S400 (step S402). The processing section 20C counts the number of pieces of data in which the non-defective product “0” or the defective product “1” is set in one piece of the one-dimensional post-addition partial data Din_1\hat{ }i, thereby calculating the number of pieces of data nv in the analysis target region 30A in the one-dimensional post-addition original data Din_1.

The number of pieces of data nv in the analysis target region 30A in the one-dimensional post-addition original data Din_1 coincides with the value of k in the post-addition original data Din_1. Furthermore, the number of pieces of data nv and the value k in the analysis target region 30A in the one-dimensional post-addition original data Din_1 coincide with the number of pieces of data of the region 32A in which the setting target code is defined in the processing pattern Pd used at the time of generating the post-addition original data Din_1.

Next, the processing section 20C randomly selects the replacement function Rp from the set of replacement functions represented by {0, . . . , nv−1}→{0, . . . , nv−1} using the number of pieces of data nv calculated in step S402 (step S404).

Next, the processing section 20C specifies the number of pieces of data num of the region 32A in which the setting target code is defined in the processing pattern Pd used at the time of generating the post-addition original data Din_1 acquired in step S400 (step S406). The processing in step S406 is similar to that in step S302 described above.

Then, the processing section 20C repeats the processing of steps S408 to S414 for each of the plurality of pieces of post-addition partial data Din_1\hat{ }i of the post-addition original data Din_1 acquired in step S400.

Specifically, the processing section 20C sets “0” to j, which is a count value for counting the data value vin_i_j of the processed position coordinates in the post-addition original data Din_1\hat{ }i to be processed (step S408).

Then, the processing section 20C determines whether or not the count value j of the data value vin_i_j of the processed position coordinates is less than or equal to the number of pieces of data num specified in step S406 (step S410). When an affirmative determination is made in step S410 (step S410: Yes), the process proceeds to step S412.

In step S412, the processing section 20C adds (Rp(j), vin1_i_{Rp(j)} to the i-th one-dimensional processed data Dout_1\hat{ }i being generated (step S412). That is, the processing section 20C sets the data value in the position coordinate Rp(j) in the i-th one-dimensional processed data Dout_1\hat{ }i being generated. Here, Rp(j) is a position coordinate obtained by coordinate-replacing the position coordinate j of the data value of the processing target in the post-addition original data Din_1\hat{ }i by the replacement function Rp selected in step S404.

Then, the processing section 20C counts up j by 1 (step S414), and proceeds to step S410 described above. When a negative determination is made in step S410 (step S410: No), this routine is ended.

The processing section 20C performs the coordinate replacement process illustrated in FIG. 10, thereby generating the one-dimensional processed partial data Dout_1\hat{ }i in which the position coordinates of the data values in the analysis target region 30A are shuffled from the one-dimensional post-addition partial data Din_1\hat{ }i generated by the addition process.

Next, a detailed flow of the two-dimensional data conversion process (step S204 in FIG. 8) executed by the processing section 20C will be described.

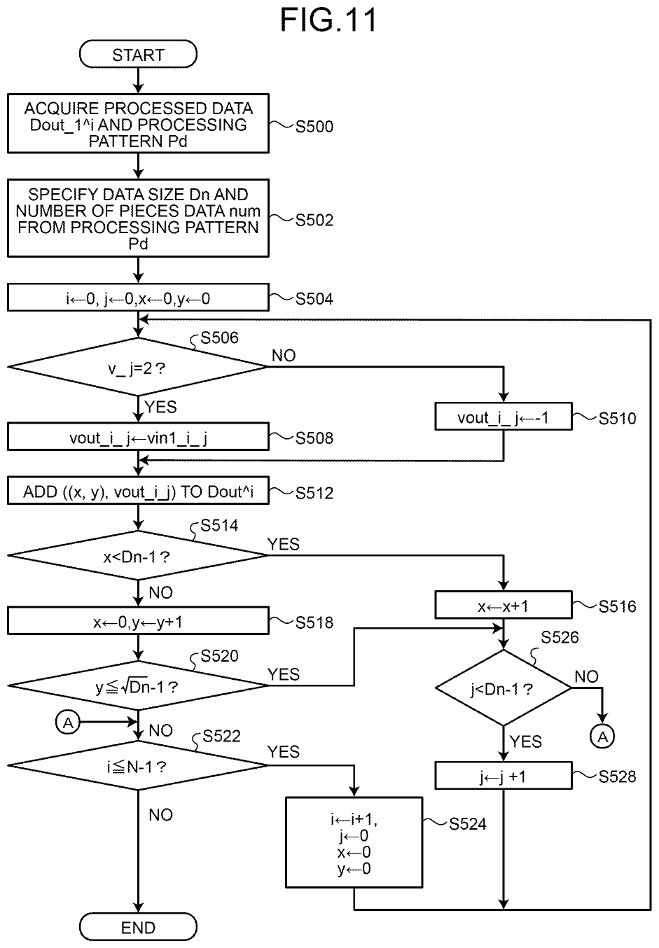

FIG. 11 is a flowchart illustrating an example of a flow of the two-dimensional data conversion process executed by the processing section 20C. The flowchart of FIG. 11 is a flowchart illustrating a detailed flow of the two-dimensional data conversion process in step S204 of FIG. 8.

The processing section 20C acquires a plurality of pieces of one-dimensional processed partial data Dout_1\hat{ }i generated by the addition process and the coordinate replacement process and the processing pattern Pd used at the time of the addition process (step S500).

Then, the processing section 20C specifies the data size Dn of the processing pattern Pd acquired in step S500 and the number of pieces of data num in the region 32A in which the setting target code is defined (step S502).

Then, the processing section 20C sets “0” to i, j, x, and y (step S504). Specifically, the processing section 20C sets “0” to the count value i for counting the one-dimensional processed partial data Dout_1\hat{ }i subjected to the two-dimensional data conversion process. Furthermore, the processing section 20C sets “0” to the count value j for counting the data value vin1_i_j of the processed position coordinates in the one-dimensional processed partial data Dout_1\hat{ }i to be processed. Furthermore, the processing section 20C sets (0, 0), which is the initial position, in position coordinates (x, y) in the two-dimensional processed partial data Dout\hat{ }i being generated.

Then, the processing section 20C determines whether or not the code v_j defined in the position coordinates (x, y) of the processing target in the processing pattern Pd acquired in step S500 is the setting target code “2” indicating that it is the setting target of the data value (step S506).

When an affirmative determination is made in step S506 (step S506: Yes), the process proceeds to step S508. In step S508, as the data value vout_i_j to be set to the position coordinates (x, y) of the processing target in the two-dimensional processed data Dout being generated, a data value vin1_i_j set j-th from the head, which is the position of the processing target in the one-dimensional processed partial data Dout_1_i of the processing target, is set (step S508). Then, the process proceeds to step S512.

When a negative determination is made in step S506 (step S506: No), the process proceeds to step S510. In step S510, “−1” representing “not to be analyzed” is set as the data value vout_i_j set to the position coordinates (x, y) of the processing target in the two-dimensional processed data Dout being generated (step S510). Then, the process proceeds to step S512.

In step S512, the processing section 20C adds ((x, y), vout_i_j) to the two-dimensional processed data Dout_i being generated (step S512). That is, the processing section 20C adds the data value vout_i_j set in step S510 or step S508 to the position coordinates (x, y) in the two-dimensional processed data Dout_i being generated.

Then, the processing section 20C determines whether or not the position coordinate x in the x-axis direction is less than or equal to the data size √Dn−1 specified in step S502 (step S514). When an affirmative determination is made in step S514 (step S514: Yes), the process proceeds to step S516.

In step S516, the processing section 20C counts up the position coordinate x of the processing target in the x-axis direction by 1 (step S516), and proceeds to step S526 described later.

When a negative determination is made in step S514 (step S514: No), the process proceeds to step S518. In step S518, the processing section 20C sets 0 to x of the position coordinates (x, y) of the processing target and counts up y by 1 (step S518). Then, the processing section 20C determines whether or not the position coordinate y of the processing target in the y-axis direction is less than or equal to the data size √Dn−1 specified in step S502 (step S520). When an affirmative determination is made in step S520 (step S520: Yes), the process proceeds to step S526 described later. When a negative determination is made in step S520 (step S520: No), the process proceeds to step S522.

In step S522, the processing section 20C determines whether or not the count value i of the one-dimensional processed data Dout_1\hat{ }i subjected to the two-dimensional data conversion process is N−1 or less (step S522). When a negative determination is made in step S522 (step S522: No), this routine is ended. When an affirmative determination is made in step S522 (step S522: Yes), the process proceeds to step S524.

In step S524, the processing section 20C counts up the count value i of the one-dimensional processed data Dout_1\hat{ }i subjected to the two-dimensional data conversion process by 1, sets “0” to j, sets “0” to x, and sets “0” to y (step S524). Then, the process proceeds to step S506 described above.

Furthermore, in step S526, the processing section 20C determines whether or not the count value j for counting the data value vin1_i_j of the processed position coordinates in the one-dimensional processed data Dout_1\hat{ }i to be processed is less than Dn−1 (step S526).

When a negative determination is made in step S526 (step S526: No), the process returns to step S522. On the other hand, when an affirmative determination is made in step S526 (step S526: Yes), the processing section 20C counts up j by 1 (step S528), and returns to step S506 described above.

By the processing section 20C executing the two-dimensional data conversion process illustrated in FIG. 11, the one-dimensional processed data Dout_1 including a plurality of pieces of one-dimensional processed partial data Dout_1\hat{ }i is converted into two-dimensional processed data Dout including a plurality of pieces of two-dimensional processed data Dout\hat{ }i.

As described above, the information processing apparatus 10 of the present embodiment includes the processing section 20C. The processing section 20C generates processed data Dout obtained by performing the addition process of adding a predetermined data value representing an analysis target to position coordinates of a non-analysis target region 30B in the original data Din with respect to the original data Din including a group of a plurality of data values arranged respectively at position coordinates along a predetermined direction on the map M.

Since the processing section 20C performs the addition process of adding the predetermined data value representing the analysis target to the position coordinates of the non-analysis target region 30B in the original data Din, the processed data Dout generated by the addition process is difficult to estimate the original data Din from the processed data Dout. Therefore, the processing section 20C can generate the processed data Dout capable of suppressing leakage of confidential information.

Here, the average value for each type of state value, the number of state values of each type, and the ratio of the state values of each type, represented by the data value of each position coordinate of the original data Din, are handled as confidential information such as manufacturing know-how, a production amount, a production plan, a manufacturing technology level, and a manufacturing cost of an analysis target such as a silicon wafer represented by the original data Din.

On the other hand, the processing section 20C of the present embodiment performs the addition process of adding a predetermined data value representing the analysis target to the position coordinates of the non-analysis target region 30B in the original data Din, thereby generating the processed data Dout. Therefore, in the processed data Dout, the average value for each type of state value, the number of state values of each type, and the ratio of the state values of each type, which are represented by the data value of each position coordinate of the original data Din, make it difficult to estimate confidential information such as manufacturing know-how, a production amount, a production plan, a manufacturing technology level, and a manufacturing cost of an analysis target such as a silicon wafer represented by the original data Din.

Therefore, the processing section 20C can suppress leakage of confidential information by generating the processed data Dout as data to be delivered to the analysis apparatus 12.

Therefore, the information processing apparatus 10 according to the present embodiment can suppress leakage of confidential information.

Furthermore, at the time of clustering the plurality of pieces of original data Din, a distance L1 and a distance L2 between the plurality of pieces of original data Din are used. The distance L2 is a value used at the time of clustering data, and is a Euclidean distance between data feature amounts. The distance L2 is the shortest distance between the data feature amounts. The distance L1 is a Manhattan distance between data feature amounts.

The processing section 20C performs the addition process of adding a predetermined data value representing the analysis target to the position coordinates of the non-analysis target region 30B in the original data Din using one processing pattern Pd for the plurality of pieces of original data Din, thereby generating the processed data Dout.

Therefore, the distance L1 and the distance L2 between the plurality of original data Din coincide with the distance L1 and the distance L2 between the plurality of processed data Dout. Therefore, the processing section 20C can generate a plurality of processed data Dout so as not to affect the analysis result by clustering.

Therefore, the information processing apparatus 10 of the present embodiment can generate the processed data Dout having different ratios of the types of the state values represented by the included data values with respect to the original data Din while maintaining the L1 distance and the L2 distance between the plurality of pieces of original data Din. Therefore, in a case where the average value for each type of state value, the number of state values of each type, and the proportion of the state values of each type represented by the data value of each position coordinate of the original data Din are confidential information, it is possible to make it difficult to estimate the confidential information from the processed data Dout.

Further, the processing section 20C performs both the addition process of adding a predetermined data value representing the analysis target to the position coordinates of the non-analysis target region 30B in the original data Din and the coordinate replacement process, thereby generating the processed data Dout.

Therefore, by generating the processed data Dout as data to be delivered to the analysis apparatus 12, the processing section 20C can further improve suppression of leakage of confidential information.

Note that, in the flowchart of the addition process illustrated in FIG. 9, a mode in which the processing section 20C adds the predetermined data value to each of the plurality of pieces of original data Din is “0” representing the non-defective product has been described as an example. By using “0” representing a non-defective product as the added predetermined data value, the processing section 20C can generate the processed data Dout representing a higher yield rate than the original data Din.

However, the predetermined data value added to each of the plurality of pieces of original data Din by the processing section 20C indicates that it is an object to be analyzed and may be the same data value among the plurality of pieces of original data Din. Therefore, for example, the processing section 20C may use “1” representing the defective product as the predetermined data value to be added to each of the plurality of pieces of original data Din. By using “1” representing a defective product as the added predetermined data value, the processing section 20C can generate the processed data Dout representing a yield rate lower than the original data Din.

Furthermore, the processing section 20C may add a predetermined non-defective product “0” or a defective product “1” as the predetermined data value to be added, or may determine the predetermined data value to be added according to the original data Din. Specifically, as described above, the processing section 20C may use, as the predetermined data value to be added, a data value representing the largest number of states in the analysis target region 30A among a plurality of types of states represented by the data value indicated in the analysis target region 30A of the original data Din. For example, a case where a data value representing the non-defective product “0” is the largest among the non-defective product “0” and the defective product “1”, which are examples of the data value representing the state represented by the data value represented in the analysis target region 30A of the plurality of original data Din, is included in the analysis target region 30A of the plurality of original data Din is assumed. In this case, the processing section 20C may use “0” representing a non-defective product as the predetermined data value to be added.

By using the data value indicating the state most included in the analysis target region 30A of the original data Din as the added predetermined data value, the processing section 20C can generate the processed data Dout having a yield rate different from that of the original data Din while making it difficult to specify the added data value.

Furthermore, the processing section 20C may use the non-defective product “0” and the defective product “1” at a predetermined ratio as the predetermined data value to be added. Furthermore, this ratio may be stored in the storage unit 22 in advance, or may be settable by an operation instruction of the UI unit 26 by the user. By using the predetermined non-defective product “0” and the defective product “1” as the predetermined data values to be added, it is possible to generate the processed data Dout indicating a yield rate different from that of the original data Din while making it difficult to estimate from the processed data Dout of the processing method performed on the original data Din.

### Second Embodiment

In the embodiment described above, a mode has been described in which the processed data Dout is generated by performing the addition process of adding the predetermined data value to the original data Din. In the present embodiment, a mode will be described in which the processed data Dout is generated by performing a deletion process of deleting at least some data values of the original data Din.

In the present embodiment, elements similar to those in the above embodiment are denoted by the same reference signs, and a detailed description thereof will be omitted.

FIG. 1 is a schematic diagram illustrating an example of an information processing system 1B according to the present embodiment. The information processing system 1B is similar to the information processing system 1 of the above embodiment except that an information processing apparatus 10B is provided instead of the information processing apparatus 10.

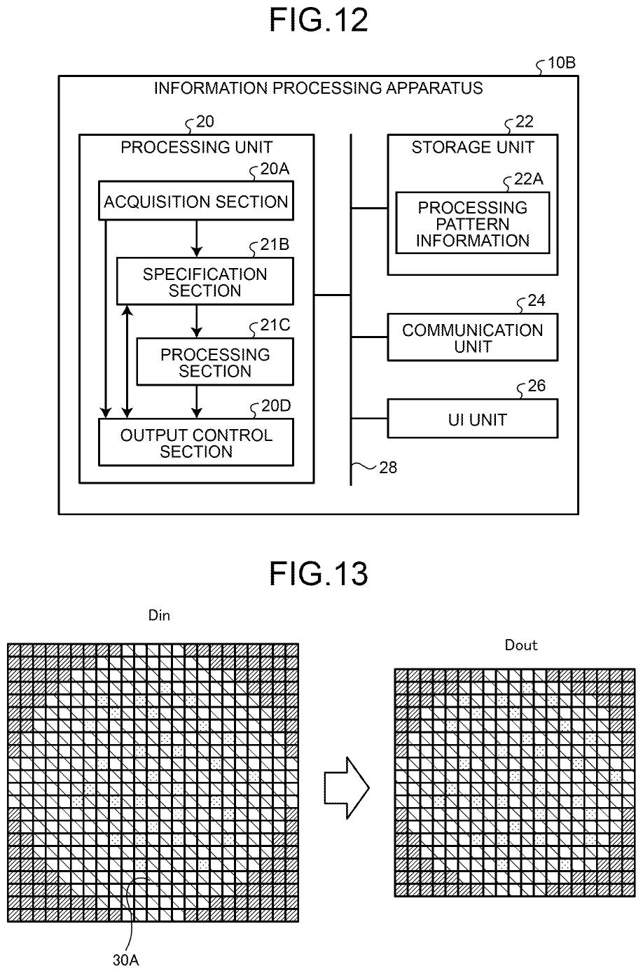

FIG. 12 is a block diagram illustrating an example of a functional configuration of the information processing apparatus 10B.

The information processing apparatus 10B includes a processing unit 21, a storage unit 22, a communication unit 24, and a UI unit 26. The information processing apparatus 10B is similar to the information processing apparatus 10 of the above embodiment except that the processing unit 21 is provided instead of the processing unit 20.

The processing unit 21 includes an acquisition section 20A, a specification section 21B, a processing section 21C, and an output control section 20D. The processing unit 21 is similar to the processing unit 20 of the above embodiment except that the specification section 21B and the processing section 21C are included instead of the specification section 20B and the processing section 20C.

The specification section 21B specifies a processing pattern Pd used for processing each partial data Din\hat{ }i of the plurality of pieces of original data Din acquired by the acquisition section 20A. The specification section 21B specifies one processing pattern Pd for a group of partial data Din\hat{ }i of a plurality of pieces of original data Din to be processed acquired by the acquisition section 20A.

The specification section 21B specifies, from processing pattern information 22A, the processing pattern Pd of 1 that satisfies the specifying condition according to the group of the partial data Din\hat{ }i of the plurality of pieces of original data Din acquired by the acquisition section 20A.

Specifically, the specification section 21B specifies the processing pattern Pd having the region 32A in which the setting target code is defined, and having the number of pieces of data being less than the number of pieces of data of the analysis target region 30A included in each partial data Din\hat{ }i of the plurality of pieces of original data Din acquired by the acquisition section 20A. Furthermore, the specification section 21B may specify the processing pattern Pd having the region 32A in which the setting target code is defined, and having the number of pieces of data being less than the number of pieces of data of the analysis target region 30A included in each partial data Din\hat{ }i of the plurality of pieces of original data Din acquired by the acquisition section 20A, and having a data size equal to or less than the data size of the original data Din.

In the present embodiment, a mode will be described in which the specification section 21B specifies the processing pattern Pd that satisfies a specific condition that the number of pieces of data is less than or equal to the data size of each piece of partial data Din\hat{ }i of the original data Din and less than the number of pieces of data of the analysis target region 30A included in the partial data Din\hat{ }i.

Specifically, the specification section 21B measures the number of pieces of data of the data value in the analysis target region 30A in the partial data Din\hat{ }i of the original data Din.

As described above, the acquisition section 20A acquires, as the plurality of pieces of original data Din to be processed, the plurality of pieces of original data Din including partial data Din\hat{ }i having the same data size and the same number of pieces of data in the analysis target region 30A. Therefore, the specification section 21B may measure the data size of one piece of partial data Din\hat{ }i among the plurality of pieces of original data Din acquired by the acquisition section 20A and the number of pieces of data in the analysis target region 30A.

Furthermore, the specification section 21B calculates the number of position coordinates of which data values match between the analysis target regions 30A of the plurality of pieces of original data Din acquired by the acquisition section 20A.

Then, the specification section 21B specifies the processing pattern Pd in which a range larger than the number obtained by subtracting the number of position coordinates at which the data values match between the analysis target regions 30A of the plurality of pieces of original data Din from the number of pieces of data in the analysis target region 30A of the partial data Din\hat{ }i of the original data Din and smaller than the number of pieces of data of the data values in the analysis target region 30A is set as the number of pieces of data of the region 32A in which the setting target code is defined.

Specifically, it is assumed that the number of pieces of data of the data values in the analysis target region 30A in the partial data Din\hat{ }i of the original data Din is 68. Furthermore, it is assumed that the number of position coordinates at which the data values match between the analysis target regions 30A of the plurality of pieces of original data Din is 50. In this case, the specification section 21B calculates a range of more than 18, which is a number obtained by subtracting 50 from 68, and less than 68, which is the number of pieces of data of the data value in the analysis target region 30A. That is, the specification section 21B calculates a range of 19 or more and 67 or less. Then, the specification section 21B specifies the processing pattern Pd in which the calculated range of 19 or more and 67 or less is set as the number of pieces of data of the region 32A in which the setting target code is defined. When the processing pattern Pd illustrated in FIGS. 4A and 4B is registered in the processing pattern information 22A, the specification section 21B acquires the processing pattern Pd\hat{ }i and the processing pattern Pd\hat{ }2 from the processing pattern information 22A as the processing pattern Pd that matches the specific condition.

The specification section 21B specifies arbitrary one piece of processing pattern information 22A as the processing pattern Pd used for processing the original data Din from the acquired one or plurality of the processing patterns Pd.

Furthermore, the specification section 21B acquires one or a predetermined number of the plurality of processing patterns Pd satisfying the specific condition from the processing pattern information 22A. Then, the output control section 20D outputs a list of one or the plurality of processing patterns Pd acquired by the specification section 21B to the UI unit 26. For example, a display screen representing the plurality of processing patterns Pd illustrated in FIG. 4B is displayed on the UI unit 26. The user operates the UI unit 26 while visually recognizing the UI unit 26 to select the desired one processing pattern Pd.

The specification section 21B specifies one processing pattern Pd selected by an operation instruction of the UI unit 26 by the user from among one or the plurality of processing patterns Pd output to the UI unit 26 as the processing pattern Pd used for processing the partial data Din\hat{ }i of the plurality of pieces of original data Din.

Furthermore, the specification section 21B acquires information indicating a processing parameter from the UI unit 26. For example, the output control section 20D displays a screen prompting the input of the processing parameter on the UI unit 26. The user inputs a desired processing parameter by operating the UI unit 26. The specification section 21B acquires information indicating the processing parameter from the UI unit 26. Then, the specification section 21B selects the processing pattern Pd corresponding to the specific condition and the processing parameter for which the input is received from the processing pattern information 22A. The specification section 21B specifies the selected processing pattern Pd as the processing pattern Pd used for processing the partial data Din\hat{ }i of the plurality of original data Din.

Furthermore, the specification section 21B acquires the processing pattern Pd satisfying the specific condition from the processing pattern information 22A. Then, the specification section 21B outputs a list of the acquired processing patterns Pd to the UI unit 26. Then, the specification section 21B may specify one Pd selected by an operation instruction of the UI unit 26 by the user as the processing pattern Pd used for processing the partial data Din\hat{ }i of the plurality of pieces of original data Din.

Note that the output control section 20D may further output the one processing pattern Pd specified by the specification section 21B to the UI unit 26 as the processing pattern Pd used for processing the partial data Din\hat{ }i of the plurality of pieces of original data Din acquired by the acquisition section 20A. Furthermore, the output control section 20D may display partial data Din the plurality of pieces of original data Din acquired to the UI unit 26 when the acquisition section 20A acquires the plurality of pieces of original data Din.

Next, the processing section 21C will be described.

For the partial data Din\hat{ }i of the plurality of pieces of original data Din acquired by the acquisition section 20A, the processing section 21C performs the deletion process of deleting data values of at least some position coordinates of which data values match between the plurality of pieces of partial data Din\hat{ }i in the original data Din.

It is preferable that the processing section 21C executes the deletion process of deleting data values of at least some position coordinates of which data values match between the plurality of pieces of partial data Din\hat{ }i at least in the analysis target region 30A in the partial data Din\hat{ }i of the original data Din.

Specifically, the processing section 21C executes the deletion process on each of the plurality of pieces of partial data Din\hat{ }i using the one processing pattern Pd specified by the specification section 20B.

The processing section 21C calculates a subtraction result obtained by subtracting the number of pieces of data of the analysis target region 30A that is included in the processing pattern Pd specified by the specification section 21B, and in which the setting target code is defined from the number of pieces of data of the analysis target region 32A included in the partial data Din\hat{ }i. Then, the processing section 21C obtains the calculated subtraction result as the deletion number of the data value to be deleted from the non-analysis target region 30B of the partial data Din\hat{ }i.

Then, the processing section 21C performs a deletion process of deleting, from the partial data Din\hat{ }i, the data value of each of the position coordinates in which the data value matches between the plurality of pieces of partial data Din\hat{ }i among the position coordinates in the analysis target region 30A in the partial data Din\hat{ }i of the plurality of pieces of original data Din acquired by the acquisition section 20A and the number of pieces of position coordinates of the obtained deletion number.

The processing section 21C executes this deletion process using the processing pattern Pd.

As described above, a mode will be described in which the specification section 21B specifies the processing pattern Pd that satisfies the specific condition that the number of pieces of data is less than or equal to the data size of the partial data Din\hat{ }i and is less than the number of pieces of data of the analysis target region 30A included in the partial data Din\hat{ }i.

For example, it is assumed that the number of pieces of data of data values in the analysis target region 30A in the partial data Din\hat{ }i is 68. Furthermore, it is assumed that the number of position coordinates at which the data values match between the analysis target regions 30A of the plurality of pieces of partial data Din\hat{ }i is 50. Then, it is assumed that the specification section 21B specifies the processing pattern Pd2 in which the number of pieces of data in the region 32A in which the setting target code is defined is “40” from the processing pattern information 22A (See FIGS. 4A and 4B).

In this case, the processing section 21C determines, as the deletion number of pieces of data values to be deleted from the analysis target region 30A of the original data Din, 28 obtained by subtracting 40, which is the number of pieces of data in the defined region 32A of the setting target code in the specified processing pattern Pd, from 68, which is the number of pieces of data values in the analysis target region 30A of the partial data Din of the original data Din.

Then, for each of the plurality of pieces of partial data Din\hat{ }i, the processing section 21C converts the partial data Din\hat{ }i of the original data Din into the one-dimensional partial data Din_1\hat{ }i, sequentially reads each piece of the one-dimensional original data Din\hat{ }including the one-dimensional partial data Din_1\hat{ }i, and sequentially sets the data value to each position coordinate of the post-deletion original data, which is the data after the deletion process, while deleting the data value of the position coordinate having the same data value in the analysis target region 30A of the partial data Din\hat{ }i of the plurality of pieces of original data Din by the determined deletion number. In other words, the processing section 21C generates the post-deletion original data, which is the data after the deletion process, by sequentially setting the post-deletion original data after deleting the data values corresponding to the deletion number from the data values in the analysis target region 30A of the partial data Din\hat{ }i of the original data Din to each of the plurality of position coordinates included in the region 32A in which the setting target code is defined in the processing pattern Pd specified by the specification section 21B.

The processing section 21C may use the post-deletion original data generated by the data value deletion process for the original data Din as the processed data Dout.

FIG. 13 is an explanatory diagram of an example of the deletion process. For example, when the processing section 21C performs the deletion process on the original data Din, at least a part of data values of position coordinates having the same data value among the plurality of pieces of original data Din in the analysis target region 30A in the original data Din is deleted, and the processed data Dout which is the post-deletion original data is generated.

Returning to FIG. 12, the description will be continued.

In the present embodiment, the processing section 21C further performs the coordinate replacement process of replacing position coordinates of at least some data values of the plurality of data values in the analysis target region 30A with other position coordinates in the analysis target region 30A. In the present embodiment, a mode in which the processing section 21C performs the deletion process and the coordinate replacement process on each partial data Din\hat{ }i of the original data Din to generate processed data Dout will be described as an example.

The processing section 21C may perform the coordinate replacement process at any one timing before or after the deletion process is performed on the original data Din. For example, the processing section 21C may delete the data value by the deletion process after performing the coordinate replacement process on the original data Din. Furthermore, the processing section 21C may perform the coordinate replacement process at both timings before and after performing the deletion process on the original data Din.

In the present embodiment, a mode in which the processing section 21C performs the coordinate replacement process after deleting the data value from the original data Din by the deletion process will be described as an example. Since the coordinate replacement process by the processing section 21C is similar to the coordinate replacement process by the processing section 20C described in the above embodiment, the description thereof will be omitted.

The processing section 21C generates the processed data Dout subjected to the deletion process and the coordinate replacement process by performing the coordinate replacement process on all the position coordinates in the analysis target region 30A in the post-addition original data.

The output control section 20D outputs various types of information. Since the output control section 20D is similar to that of the above embodiment, the description thereof will be omitted.

Next, an example of a flow of information processing executed by the information processing apparatus 10B according to the present embodiment will be described.

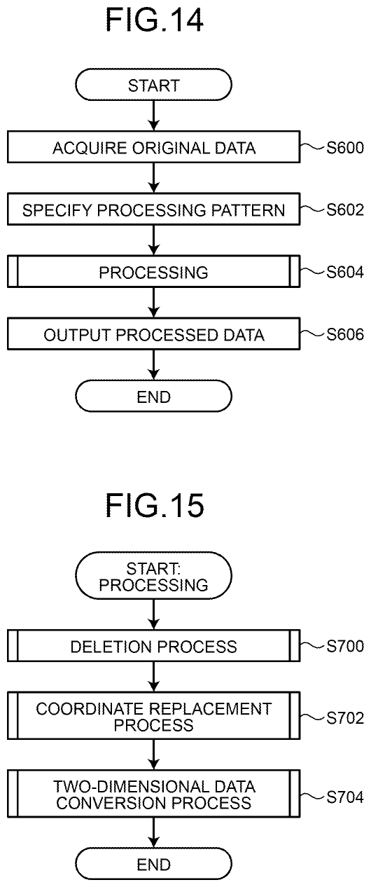

FIG. 14 is a flowchart illustrating an example of a flow of information processing executed by the information processing apparatus 10B according to the present embodiment.

The acquisition section 20A acquires a plurality of pieces of original data Din to be processed (step S600).

The specification section 21B specifies one processing pattern Pd corresponding to the original data Din acquired in step S600 from the processing pattern information 22A stored in the storage unit 22 (step S602). The specification section 21B specifies the processing pattern Pd having a data size smaller than or equal to the data size of the partial data Din\hat{ }i of the plurality of pieces of original data Din acquired in step S600, and having the region 32A in which the setting target code is defined, and the number of pieces of data in which is less than the number of pieces of data of the analysis target region 30A included in the partial data Din\hat{ }i.

Then, the processing section 21C generates a plurality of pieces of processed data Dout by performing processing including the deletion process and the coordinate replacement process on the partial data Din\hat{ }i of the plurality of pieces of original data Din acquired in step S600 (step S604). A detailed flow of the processing in step S604 will be described later.

The output control section 20D outputs the plurality of processed data Dout generated by the processing in step S604 (step S606). For example, the output control section 20D outputs the plurality of processed data Dout to at least one of the storage unit 22, the UI unit 26, and the analysis apparatus 12. Then, this routine is ended.

Next, a detailed flow of the processing (step S604 in FIG. 14) executed by the processing section 21C will be described.

FIG. 15 is a flowchart illustrating an example of a flow of processing executed by the processing section 21C. The flowchart of FIG. 15 is a flowchart illustrating a detailed flow of the processing in step S604 of FIG. 15.

The processing section 21C performs the deletion process on the partial data Din\hat{ }i of the plurality of pieces of original data Din acquired in step S600 (see FIG. 14) using the processing pattern Pd specified in step S602 (see FIG. 14) (step S700). Details of the flow of the deletion process in step S700 will be described later.

Then, the processing section 21C performs the coordinate replacement process on the one-dimensional post-deletion original data generated by the deletion process in step S700 (step S702). Details of the flow of the coordinate replacement process in step S702 will be described later.

The processing section 21C converts one-dimensional processed data Dout_1 generated by the coordinate replacement process of step S702 into two-dimensional data (step S704), and ends this routine. The coordinate replacement process in step S704 is similar to the coordinate replacement process (See step S204 in FIG. 8, and FIG. 10.) described in the above embodiment, and thus a detailed description thereof will be omitted.

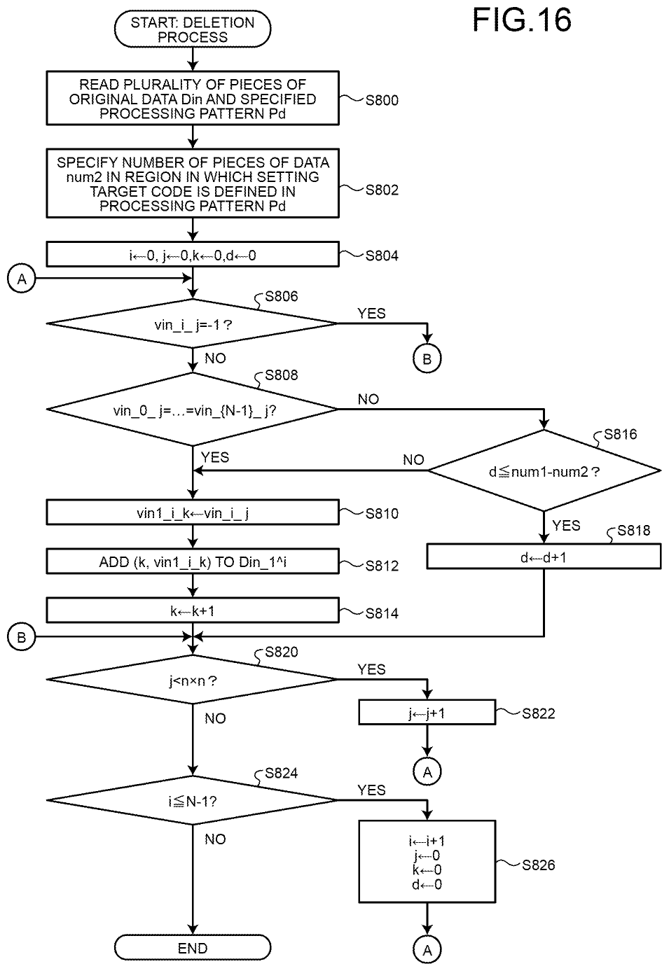

FIG. 16 is a flowchart illustrating an example of a flow of the deletion process. The flowchart of FIG. 16 is a flowchart illustrating a detailed flow of the deletion process in step S700 of FIG. 15.

In the deletion process illustrated in FIG. 16, the processing section 21C converts each of the partial data Din\hat{ }i of the plurality of pieces of original data Din acquired by the acquisition section 20A into the one-dimensional original data Din_1\hat{ }i, sequentially reads each piece of the one-dimensional partial data Din_1\hat{ }i, and sequentially sets the data value to each position coordinate of the post-deletion original data, which is the data after the deletion process, while deleting the data value of the position coordinate having the same data value in the analysis target region 30A of the plurality of pieces of partial data Din_1\hat{ }i by the determined deletion number.

In FIG. 16, a mode in which the data value of the position coordinates at which the data values match in the analysis target region 30A of the partial data Din\hat{ }i of the plurality of pieces of original data Din is “1” representing the defective product will be described as an example.

First, the processing section 21C reads partial data Din\hat{ }i of original data Din, which is a plurality of pieces of two-dimensional data acquired by the acquisition section 20A, and the processing pattern Pd specified by the specification section 21B (step S800). Then, the processing section 21C specifies the number of pieces of data num2 of the region 32A in which the setting target code “2” is defined in the processing pattern Pd specified by the specification section 21B (step S802).

Then, the processing section 21C performs a process of setting the partial data Din\hat{ }i as one-dimensional partial data Din_1\hat{ }i for each of the partial data Din\hat{ }i as two-dimensional data, sequentially reading the data values for each position coordinate, and deleting the data values of the position coordinates having the same data value among the analysis target regions 30A of the plurality of partial data Din\hat{ }i until the number of subtractions is reached. The subtraction number is a value obtained by subtracting the number of pieces of data num2 specified in step S802 from the number of pieces of data num1 of the analysis target region 30A included in the partial data Din\hat{ }i.

Specifically, the processing section 20c sets each of i, j, k, and d to “0” as an initial value (step S804).

i is a count value for counting the partial data Din\hat{ }i of the original data Din subjected to the deletion process, and can take a value in a range of 0 to N−1. j is a count value for counting the data value vin_i_j of the processed position coordinates in the partial data Din\hat{ }i to be processed, and may be a value in a range of 0 or more and n×n−1 or less. k is a count value for counting a data value representing the non-defective product “0” or the defective product “1” included in the one-dimensional post-deletion original data Din_1\hat{ }i after the data value is deleted, the data value being generated from the partial data Din\hat{ }i by the deletion process by the processing section 21C. k may have a value in a range of 0 or more and num2−1 or less. d is a count value for counting the number of pieces of data values deleted from the original data Din, and may take a value of 0 or more (num1−num2) or less.

Then, the processing section 21C determines whether or not the data value v_i_j of the position coordinates of the unprocessed first processing target in the original data Din to be processed is “−1” representing non-analysis target (step S806). When a negative determination is made in step S806 (step S806: No), the process proceeds to step S808. When an affirmative determination is made in step S806 (step S806: Yes), the process proceeds to step S820 described later.

In step S808, the processing section 21C determines whether the data value vin_i_j of the position coordinates of the processing target is the same as the data value of the same position coordinates in each of the partial data Din\hat{ }i of the other plurality of pieces of original data Din acquired in step S800 (step S808).

When an affirmative determination is made in step S808 (step S808: Yes), the process proceeds to step S810. In step S810, the processing section 21C sets the data value vin_i_j of the position coordinates of the processing target used for the determination in step S806 as the data value vin1_i_k which is the state value of the head position for which the data value is not set in the i-th one-dimensional post-deletion original data Din_1\hat{ }i being generated (step S810).

The processing section 21C adds data (k, vin1_i_k) to the i-th one-dimensional post-deletion original data Din_1\hat{ }i being generated (step S812). That is, the processing section 21C sets the data value vin1_i_k set in step S810 to k, which is the head position with no data value set, in the i-th one-dimensional post-deletion original data Din_1\hat{ }i being generated.

Then, the processing section 21C counts up k by 1 (step S814), and proceeds to step S820 described later.

On the other hand, when a negative determination is made in step S808 (step S808: No), the process proceeds to step S816. In step S816, the processing section 21C determines whether d, which is the count value of the data value deleted from the original data Din, is less than or equal to num1−num2, which is the deletion number. When a negative determination is made in step S816 (step S816: No), the process proceeds to step S810. When an affirmative determination is made in step S816 (step S816: Yes), the process proceeds to step S818. In step S818, d is counted up by 1 (step S818), and the process proceeds to step S820.

In step S820, the processing section 21C determines whether or not j is less than n×n (step S820). The processing section 21C determines whether or not the count value j of the processed position coordinates is less than n×n. When an affirmative determination is made in step S820 (step S820: Yes), the process proceeds to step S822. The processing section 21C counts up j by 1 (step S822), and returns to step S806.

When a negative determination is made in step S820 (step S820: No), the process proceeds to step S824. In step S824, the processing section 21C determines whether or not i is less than or equal to N−1 (step S824). N is the number of partial data Din\hat{ }i of the plurality of original data Din acquired by the acquisition section 20A. That is, the processing section 21C determines whether or not there is partial data Din\hat{ }i for which the processing in steps S806 to S824 has not been completed among the plurality of pieces of partial data Din\hat{ }i acquired by the acquisition section 20A. When an affirmative determination is made in step S824 (step S824: Yes), the process proceeds to step S826. In step S826, the processing section 21C counts up i by 1, sets j, k, and d to “0”, and then returns to step S806 described above. On the other hand, when a negative determination is made in step S824 (step S824: No), this routine is ended.

By executing the addition process illustrated in FIG. 16, the processing section 21C generates the one-dimensional post-deletion original data Din_1 in which the data value of the position coordinate having the same data value between the analysis target regions 30A of the partial data Din\hat{ }i of the plurality of pieces of original data Din is deleted from each of the plurality of pieces of two-dimensional original data Din by the number of pieces of data values corresponding to the deletion number.

Next, a detailed flow of the coordinate replacement process (step S702 in FIG. 15) executed by the processing section 21C will be described.

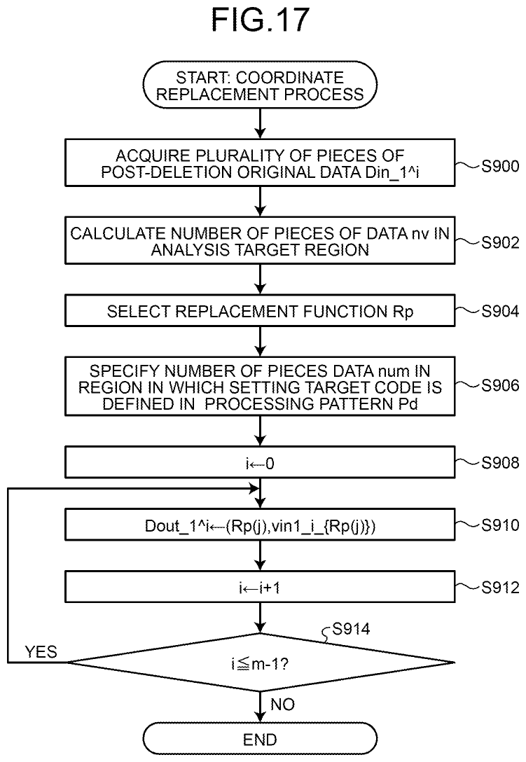

FIG. 17 is a flowchart illustrating an example of a flow of the coordinate replacement process executed by the processing section 21C. The flowchart of FIG. 17 is a flowchart illustrating a detailed flow of the processing in step S702 of FIG. 15.

The processing section 21C acquires a plurality of pieces of one-dimensional post-deletion original data Din_1 generated by the deletion process (step S900).

Then, the processing section 21C calculates the number of pieces of data nv in the analysis target region 30A in the partial data Din_1\hat{ }i of the one-dimensional post-deletion original data Din_1 acquired in step S900 (step S902). The processing section 21C counts the number of pieces of data in which the non-defective product “0” or the defective product “1” is set in the partial data Din_1\hat{ }i of one piece of one-dimensional post-deletion original data Din_1, thereby calculating the number of pieces of data nv in the analysis target region 30A in the one-dimensional post-deletion original data Din_1.

The number of pieces of data nv in the analysis target region 30A in the one-dimensional post-deletion original data Din_1 coincides with the value of k in the post-deletion original data Din_1. Furthermore, the number of pieces of data nv and k in the analysis target region 30A in the one-dimensional post-deletion original data Din_1 coincide with the number of pieces of data of the region 32A in which the setting target code is defined in the processing pattern Pd used at the time of generating the post-deletion original data Din_1.

Next, the processing section 21C randomly selects the replacement function Rp from the set of replacement functions represented by {0, . . . , nv−1}→{0, . . . , nv−1} using the number of pieces of data nv calculated in step S902 (step S904).

Next, the processing section 21C specifies the number of pieces of data num of the region 32A in which the setting target code is defined in the processing pattern Pd used at the time of generating the post-deletion original data Din_1 acquired in step S900 (step S906). The processing in step S906 is similar to that in step S802 described above.

Then, the processing section 21C sets “0” to i which is a count value for counting the processed post-deletion partial data Din_1\hat{ }i (step S908).

Then, the processing section 21C adds (Rp(j), vin1_i_{Rp(j)}) to the i-th one-dimensional processed partial data Dout_1\hat{ }i being generated (step S910). That is, the processing section 21C sets the respective data values of all the positions j in the post-deletion partial data Din_1\hat{ }i in the i-th one-dimensional processed partial data Dout_1\hat{ }i being generated to the position coordinates Rp(j) obtained by substituting the positions j by the replacement function Rp selected in step S904.

Then, the processing section 21C counts up i by 1 (step S912). The processing section 21C determines whether i is equal to or less than a value obtained by subtracting 1 from m, which is the number of the post-deletion original data Din_1\hat{ }i acquired in step S900 (step S914), and when an affirmative determination is made in step S914 (step S914: Yes), the processing returns to step S910 described above. When a negative determination is made in step S914 (step S914: No), this routine is ended.

The processing section 20C performs the coordinate replacement process illustrated in FIG. 17, thereby generating the one-dimensional processed partial data Dout_1\hat{ }i in which the position coordinates of the data values in the analysis target region 30A are shuffled from the one-dimensional post-deletion partial data Din_1\hat{ }i generated by the deletion process.

As described above, the information processing apparatus 10B according to the present embodiment includes the processing section 21C. The processing section 21C generates, for the original data Din including a group of a plurality of data values arranged respectively at position coordinates along a predetermined direction on the map M, processed data Dout including processed partial data Dout by performing the deletion process of deleting data values of at least some position coordinates of which data values match between a plurality of pieces of partial data Din\hat{ }i in the original data Din.

Since the processing section 21C performs the deletion process, it is difficult to estimate the original data Din from the processed data Dout in the processed data Dout generated by the deletion process. Specifically, in the processed data Dout, the average value for each type of state value, the number of state values of each type, and the ratio of the state values of each type represented by the data value of each position coordinate of the original data Din make it difficult to estimate confidential information such as manufacturing know-how, a production amount, a production plan, a manufacturing technology level, and a manufacturing cost of an analysis target such as a silicon wafer represented by the original data Din.

Therefore, the processing section 21C can suppress leakage of confidential information by generating the processed data Dout as data to be delivered to the analysis apparatus 12.

Therefore, the information processing apparatus 10B according to the present embodiment can suppress leakage of confidential information.

Furthermore, at the time of clustering the plurality of pieces of original data Din, a distance L1 and a distance L2 between the plurality of pieces of original data Din are used.

The processing section 21C generates processed data Dout subjected to a deletion process of deleting data values of at least some position coordinates of the original data Din having data values matching each other among the plurality of pieces of original data Din.

In order to delete the data value of the position coordinate in which the data value matches between the plurality of original data Din, the distance L1 and the distance L2 between the plurality of original data Din and the distance L1 and the distance L2 between the plurality of processed data Dout match. Therefore, the processing section 21C can generate a plurality of processed data Dout so as not to affect the analysis result by clustering.

Therefore, the information processing apparatus 10B of the present embodiment can generate the processed data Dout having different ratios of the types of the state values represented by the included data values with respect to the original data Din while maintaining the L1 distance and the L2 distance between the plurality of pieces of original data Din. Therefore, in a case where the average value for each type of state value, the number of state values of each type, and the proportion of the state values of each type represented by the data value of each position coordinate of the original data Din are confidential information, it is possible to make it difficult to estimate the confidential information from the processed data Dout.

Moreover, the processing section 21C generates the processed data Dout by performing both the deletion process and the coordinate replacement process on the original data Din.

Therefore, by generating the processed data Dout as data to be delivered to the analysis apparatus 12, the processing section 21C can further improve suppression of leakage of confidential information.

Note that, in the present embodiment, a mode has been described as an example in which the processing section 21C executes the deletion process of deleting, from the original data Din, each data value of the position coordinates having the same data value among the plurality of pieces of original data Din among the position coordinates in the analysis target region 30A in the plurality of pieces of original data Din acquired by the acquisition section 20A, the position coordinates having the deletion number.

The processing section 21C may delete, from the original data Din, the data value of the position coordinate at which the data value matches between the plurality of pieces of partial data Din\hat{ }i among the position coordinates in the analysis target region 30A in the partial data Din\hat{ }i of the plurality of pieces of original data Din, and the data value represents a specific value. The specific value is, for example, “0” representing a non-defective product or “1” representing a defective product. The specific value may be determined in advance.

Furthermore, the processing section 21C may delete, from the original data Din, a data value of a position coordinate at which a data value matches among the plurality of pieces of partial data Din\hat{ }i among position coordinates in the analysis target region 30A in the partial data Din\hat{ }i of the plurality of pieces of original data Din, the position coordinate representing the most data value (for example, “1” representing a non-defective product) included in the analysis target region 30A of the plurality of pieces of partial data Din\hat{ }i.

### Modified Example

In the first embodiment, a mode has been described in which the processed data Dout is generated by the processing section 20C performing the addition process on the original data Din. Furthermore, in the second embodiment, a mode has been described in which the processed data Dout is generated by the processing section 21C performing the deletion process on the original data Din.

However, the processing section 20C or the processing section 21C may generate the processed data Dout by performing both the deletion process and the addition process on the original data Din.

In this case, for example, the processing section 20C or the processing section 21C generates the post-addition original data Din by performing the addition process described in the first embodiment on the original data Din. Then, the processing section 20C or the processing section 21C may generate the processed data Dout by performing the deletion process described in the second embodiment on the post-addition original data Din. Furthermore, the processing section 20C or the processing section 21C generates the post-deletion original data Din by performing the deletion process described in the second embodiment on the original data Din. Then, the processing section 20C or the processing section 21C may generate the processed data Dout by performing the addition process described in the first embodiment on the post-deletion original data Din.

Furthermore, the processing section 20C or the processing section 21C may further perform the coordinate replacement process to generate the processed data Dout.

Next, an example of a hardware configuration of the information processing apparatus 10 and the information processing apparatus 10B in the above-described embodiments and a modified example will be described.

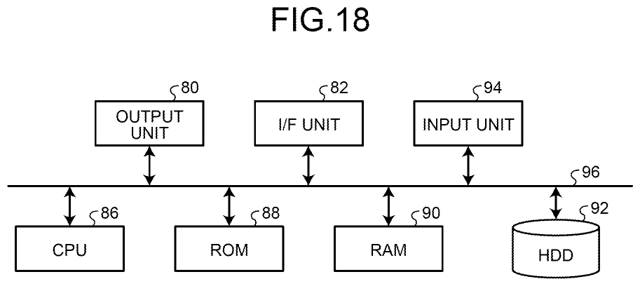

FIG. 18 is a hardware configuration diagram of an example of the information processing apparatus 10 and the information processing apparatus 10B according to the embodiments and the modified example.

The information processing apparatus 10 and the information processing apparatus 10B include a control device such as a CPU 86, a storage device such as a read only memory (ROM) 88, a random access memory (RAM) 90, and a hard disk drive (HDD) 92, an I/F unit 82 which is an interface with various devices, an output unit 80 which outputs various types of information such as output information, an input unit 94 which receives an operation by a user, and a bus 96 which connects the respective units, and have a hardware configuration using a general computer.

In the information processing apparatus 10 and the information processing apparatus 10B, the CPU 86 reads a program from the ROM 88 onto the RAM 90 and executes the program, whereby the above-described respective units are realized on a computer.

Note that the programs for executing the above-described respective processes executed by the information processing apparatus 10 and the information processing apparatus 10B may be stored in the HDD 92. Furthermore, the program for executing each of the above-described processes executed by the information processing apparatus 10 may be provided by being incorporated in the ROM 88 in advance.

Furthermore, the program for executing the above-described processes executed by the information processing apparatus 10 and the information processing apparatus 10B may be stored as a file in an installable format or an executable format in a computer-readable storage medium such as a CD-ROM, a CD-R, a memory card, a digital versatile disk (DVD), or a flexible disk (FD) and provided as a computer program product. Furthermore, the program for executing the above-described processing executed by the information processing apparatus 10 and the information processing apparatus 10B may be stored on a computer connected to a network such as the Internet and provided by being downloaded via the network. Furthermore, a program for executing the above-described processes executed by the information processing apparatus 10 and the information processing apparatus 10B may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing method executed by a computer, the method comprising
generating processed data obtained by performing,
on original data including a group of a plurality of data values arranged respectively at position coordinates along a predetermined direction on a map,
at least one of an addition process of adding a predetermined data value representing an analysis target at position coordinates in a non-analysis target region in the original data and a deletion process of deleting data values of at least part of the position coordinates in the original data, where data values at the at least part match between a plurality of pieces of the original data.

2. The method according to claim 1, wherein
the generating includes
generating the processed data subjected to at least one of the deletion process and the addition process
by using a processing pattern defining a non-setting target code representing that a data value of the original data is not to be set or a setting target code representing that a data value of the original data is to be set for each position coordinate.

3. The method according to claim 2, further comprising
specifying the processing pattern having a data size larger than a data size of the original data, and having a region in which the setting target code is defined, and a number of pieces of data in which is larger than a number of pieces of data in the analysis target region included in the original data,
wherein the generating includes
performing the addition process of adding, at position coordinates in the non-analysis target region in the original data, predetermined data values representing an analysis target, where a number of the predetermined data values is obtained by subtracting a number of pieces of data in the analysis target region included in the original data from the number of pieces of data in the region that is included in the specified processing pattern and in which the setting target code is defined.

4. The method according to claim 3, wherein
the data values are values representing states respectively at position coordinates in the original data, and
the generating includes
adding, as the predetermined data values, a data value representing a largest number of states in the analysis target region among a plurality of types of states represented by data values indicated in the analysis target region of the original data.

5. The method according to claim 3, wherein
the generating includes
generating the processed data by sequentially setting additional data obtained by adding the predetermined data values to data values in the analysis target region in the original data respectively at a plurality of position coordinates included in the region in which the setting target code is defined in the specified processing pattern.

6. The method according to claim 2, further comprising
specifying the processing pattern having a region in which the setting target code is defined, and a number of pieces of data in which is less than a number of pieces of data in the analysis target region included in the original data,
wherein the generating includes
performing the deletion process of deleting, from the original data, data values at a deletion number of position coordinates having data values matching between a plurality of pieces of the original data among position coordinates in the analysis target region in the original data, where the deletion number is a subtraction result obtained by subtracting the number of pieces of data in the region in which the setting target code is defined in the specified processing pattern, from the number of pieces of data in the analysis target region in the original data.

7. The method according to claim 6, wherein
the generating includes
generating the processed data by setting post-deletion original data obtained by deleting the deletion number of the data values from data values in the analysis target region of the original data, at position coordinates in the region in which the setting target code is defined in the specified processing pattern.

8. The method according to claim 2, wherein
the processing pattern is
a pattern in which the setting target code is defined at position coordinates in a region having a shape similar to a shape of an analysis target region in the original data.

9. The method according to claim 3, further comprising
outputting a plurality of processing patterns to an output unit,
wherein the generating includes
generating the processed data using one selected from among the plurality of output processing patterns.

10. The method according to claim 2, further comprising
outputting the processing pattern used for generating the processed data at the generating, to an output unit.

11. The method according to claim 1, wherein
the generating includes
replacing position coordinates of at least part of a plurality of data values in an analysis target region with other position coordinates in the analysis target region.

12. An information processing apparatus comprising
a processing section configured to generate processed data obtained by performing,
on original data including a group of a plurality of data values arranged respectively at position coordinates along a predetermined direction on a map,
at least one of an addition process of adding a predetermined data value representing an analysis target at position coordinates in a non-analysis target region in the original data and a deletion process of deleting data values of at least part of position coordinates in the original data, where data values at the at least part match between a plurality of pieces of the original data.

13. A computer program product comprising a computer-readable medium including programmed instructions, the instructions causing a computer to execute
generating processed data obtained by performing,
on original data including a group of a plurality of data values arranged respectively at position coordinates along a predetermined direction on a map,
at least one of an addition process of adding a predetermined data value representing an analysis target at position coordinates in a non-analysis target region in the original data and a deletion process of deleting data values of at least part of the position coordinates in the original data, where data values at the at least part match between a plurality of pieces of the original data.
